(19) United States
(12) Patent Application Publication
(10) Pub. No.: US 2020/0323232 A1
(43) Pub. Date: Oct. 15, 2020

(54) Food Stabilising Composition Comprising Plant-Derived Inhibitors of Fatty Acid Oxidation

(71) Applicant: NATUREX SA, Avignon (FR)

(72) Inventors: Simona BIRTIC, Cavaillon (FR); Mélanie Marie-Paule Patricia HEUDRE, Vedène (FR); Bérengère VANTIEGHEM, Colembert (FR); Mathieu TENON, Malemort du comtat (FR); François-Xavier PIERRE, Saint Saturnin les Avignon (FR); Antoine Charles BILY, Vedène (FR)

(21) Appl. No.: 16/759,355

(22) PCT Filed: Oct. 25, 2018
(86) PCT No.: PCT/EP2018/079351

§ 371 Date: Apr. 26, 2020

(30) Foreign Application Priority Data
Oct. 27, 2017 (GB) 1717712.2

(51) Int. Cl. A23D 7/005; C11B 5/00; A23L 27/60; A23D 7/04; A23D 7/06; A23L 3/3472; A23L 33/105

(52) U.S. Cl. CPC A23D 7/0056; C11B 5/0085; C11B 5/0092; A23L 27/60; A23V 2002/00; A23D 7/06; A23L 3/3472; A23L 33/105; A23D 7/04

(57) ABSTRACT

The present invention relates to a food stabilising composition including at least one plant derived inhibitor of fatty acid oxidation, processes for providing such compositions and methods and uses of the compositions and foodstuffs including such compositions.

The present invention relates to food stabilising compositions comprising at least one plant derived inhibitor of fatty acid oxidation, processes for providing such compositions and methods and uses of the compositions and foodstuff comprising such compositions.

Stabilising compounds and compositions, such as anti-oxidants and chelating agents, are widely used in food products that are susceptible to oxidative degeneration, such as oil oxidation.

Anti-oxidants are widely used in food products that are susceptible to oxidative degeneration. An anti-oxidant is defined by the Food and Drug Administration (21CFR 170.3) as “a substance used to preserve food by retarding deterioration, rancidity, or discolouration due to oxidation”.

Oxidative degeneration, such as oil oxidation, is typically catalysed by free metal ions, such as iron and copper ions. Traditionally, ethylenediaminetetraacetic acid (EDTA) has been used in food products to prevent oxidative degeneration and the resulting spoilage of the food product due to its capacity to chelate metals.

EDTA, however, is a synthetic or artificial ingredient, and in recent years, the use of synthetic or artificial ingredients within food products has become a concern due to the possible negative effects they may have on consumers' health.

This has resulted in an increasing public demand for natural alternatives to artificial food ingredients.

To this end spices or plant juices or plant extracts or plant products may be used in food as antioxidants and to impart flavour or colour or other organoleptical features of food matrices. One advantage of such extract is that they are perceived as natural ingredients when compared to EDTA and other anti-oxidants such as butylhydroxylanisol (BHA) and butylated hydroxytoluene (BHT). However, spices and or plant juices or plant extracts or plant products may contain components that may discolour or colour food they are incorporated into, which may prove undesirable to consumers.

Several different plant materials, such as fruit, vegetables, crops, herbs and spices have been investigated as potential sources of anti-oxidant compounds. Anti-oxidant compounds are typically present in plant material due to their importance in aiding the plants growth and development.

However, the anti-oxidant efficacy of natural plant material varies greatly. In view of this, it is not a simple matter to predict which plant material or plant extracts would provide sufficient stabilising/anti-oxidant activity or what quantities of a certain extract in food that would be required.

Additionally, in some cases the amount of plant material or plant extracted or expressed required to provide sufficient stabilising/anti-oxidant activity may prove uneconomical, or be at a level which would be acceptable due to regulatory and legislation constraints or may colour or impact the taste of the food they are incorporated into in a manner that is undesirable to consumers.

The present inventors have surprisingly found that compositions comprising at least one plant derived inhibitor of fatty acid oxidation are highly effective at stabilising food products that are susceptible to oxidative degeneration. For example, by reducing/preventing oxidative degeneration.

The term “plant derived inhibitor of fatty acid oxidation” as used herein means an extract or juice or product from a plant source that reduces, inhibits or prevents fatty acids, such as those present in foodstuff, being subjected to oxidation. For example, the plant derived inhibitor of fatty acid oxidation may act as a chelating compound.

In particular, the “plant derived inhibitor of fatty acid oxidation” may act to reduce, inhibit or prevent oxidation over a given period relative to the amount of oxidation that would have occurred in the absence of the stabilising composition. For example, a “plant derived inhibitor of fatty acid oxidation” present in the food stabilising composition of the invention may reduce, inhibit or prevent oxidation by chelating transition metals, such as Cu²⁺ and Fe²⁺ and/or may provide free radical scavenging activity.

The present inventors have found compositions comprising at least one plant derived inhibitor of fatty acid oxidation, wherein the at least one plant derived inhibitor is an extract or juice or product obtained from or obtainable from plant selected from the group consisting of cereals, pseudo-cereals, the Fabaceae family, the Lamiaceae family, the Malpighiaceae family, the Amaranthaceae family and the Lythraceae family, and combinations thereof, to be particularly effective.

Stabilising Composition

The present invention provides a food stabilising composition comprising at least one plant derived inhibitor of fatty acid oxidation, which may be referred to hereinafter as the “composition of the invention”. For example, the food stabilising composition of the invention may inhibit or prevent the oxidative degeneration of food, such as by inhibiting to or preventing the conversion of polyunsaturated fatty acid (PUFA) oils to 2,4-heptadienal and/or 2,4-decadienal.

The at least one plant derived inhibitor of fatty acid oxidation, alternatively referred to herein as the at least one plant derived inhibitor may be an extract or juice or product obtained or obtainable from the at least one plant species using processes as described herein.

In the composition of the invention, the at least one plant derived inhibitor of fatty acid oxidation may be or may form part of an extract or juice or product obtained from or obtainable from a single plant species or may be obtained from or obtainable from two, three or four or more plant species.

For example, the at least one plant derived inhibitor may be or may form part of an extract or juice or product obtained from or obtainable from at least one plant selected from the group consisting of cereals, pseudo-cereals, the Fabaceae family, the Lamiaceae family, the Malpighiaceae family, the Amaranthaceae family and the Lythraceae family, and combinations thereof, preferably the at least one plant derived inhibitor may be or may form part of an extract or juice or product obtained from or obtainable from at least one plant selected from the group consisting of the Fabaceae family, the Lamiaceae family, the Amaranthaceae family and the Lythraceae family, and combinations and mixtures thereof, such as (i) rosemary and spinach; (ii) rosemary and pea; (iii) pea; or (iv) pomegranate.

In an aspect of the invention, where the at least one plant derived inhibitor is an extract or juice or product obtained or obtainable from the Lamiaceae family, the at least one plant derived inhibitor must comprise an extract or juice or product obtained or obtainable from at least one plant selected from the group consisting of the Fabaceae family, the Amaranthaceae family and the Lythraceae family, and combinations and mixtures thereof, i.e. the extract or juice or product obtained or obtainable from the Lamiaceae family is never the only at least one plant derived inhibitor present in the food stabilising composition.

Typically, when the at least one plant is a cereal or a pseudo-cereal, the at least one plant derived inhibitor may be extracted from the seed of the plant, such as from the hull of the seed of the plant. When the at least one plant is a plant of the Fabaceae family, the Lamiaceae family, the Malpighiaceae family, the Amaranthaceae family and the to Lythraceae family, the at least one plant derived inhibitor may be extracted from the leaves and/or the fruit of the plant, such as from the fruit of the plant.

In particular, the at least one plant derived inhibitor may be or may form part of an extract or juice or product obtained from or obtainable from at least one plant selected from the group consisting of the Fabaceae family, the Lamiaceae family, the Malpighiaceae family, the Amaranthaceae family and the Lythraceae family, and mixtures thereof, i.e. an extract or juice obtained from or obtainable from spinach, peas, pomegranate, acerola and rosemary and combinations thereof, preferably the at least one plant derived inhibitor may be an extract or juice obtained from or obtainable from at least one plant selected from the group consisting of the Fabaceae family, the Lamiaceae family, the Amaranthaceae family and the Lythraceae family, and combinations and mixtures thereof, i.e. an extract or juice obtained from or obtainable from spinach, peas, pomegranate and rosemary and combinations thereof, such as (i) rosemary and spinach; (ii) rosemary and pea; (iii) pea; or (iv) pomegranate.

When the at least one plant derived inhibitor is an extract obtained from or obtainable from one, two, three or four or more plant species, the extracts may be obtained together in a single extraction or may be obtained separately and the individually obtained extracts combined together to provide the at least one plant derived inhibitor. This may be particularly advantageous if the different plant species used require different extraction techniques.

Dried juices may be obtained from concentrated fruit juices supplemented with carbonates and/or hydroxyls of different salts.

A food stabilising composition of the invention may comprise at least one plant derived inhibitor, wherein the at least one plant derived inhibitor comprises:

(a) an extract obtained from or obtainable from at least one cereal; and optionally

(b) (i) an extract obtained from or obtainable from a plant of the Lamiaceae family; and/or

(ii) an extract obtained from or obtainable from a plant of the Lythraceae family; and/or

(iii) an extract obtained from or obtainable from a plant of the Amaranthaceae family.

A food stabilising composition of the invention may comprise at least one plant derived inhibitor, wherein the at least one plant derived inhibitor comprises:

(a) an extract obtained from or obtainable from at least one pseudo-cereal; and optionally

(b) (i) an extract obtained from or obtainable from a plant from the Lamiaceae family; and/or

(ii) an extract obtained from or obtainable from a plant of the family Lythraceae and/or

(iii) an extract obtained from or obtainable from a plant of the Amaranthaceae family.

A food stabilising composition of the invention may comprise at least one plant derived inhibitor, wherein the at least one plant derived inhibitor comprises:

(a) an extract obtained from or obtainable from a plant of the Fabaceae family; and optionally

(b) (i) an extract obtained from or obtainable from a plant of the Lamiaceae family; and/or

(ii) an extract obtained from or obtainable from a plant of the Lythraceae family; and/or

(iii) an extract obtained from or obtainable from a plant of the Amaranthaceae family.

For example, a food stabilising composition of the invention may comprise at least one plant derived inhibitor, wherein the at least one plant derived inhibitor comprises:

(a) an extract obtained from or obtainable from a plant of the Fabaceae family; and optionally an extract obtained from or obtainable from a plant of the Lamiaceae family.

A food stabilising composition of the invention may comprise at least one plant derived inhibitor, wherein the at least one plant derived inhibitor comprises:

(a) an extract obtained from or obtainable from a plant of the Lamiaceae family; and optionally

(b) (i) an extract (i.e. a juice) obtained from or obtainable from a plant of the Malpighiaceae family; and/or

(ii) an extract obtained from or obtainable from a plant of the Amaranthaceae family.

For example, a food stabilising composition of the invention may comprise at least one plant derived inhibitor, wherein the at least one plant derived inhibitor comprises:

(a) an extract obtained from or obtainable from a plant of the Lamiaceae family; and

(b) (i) an extract obtained from or obtainable from a plant of the Fabaceae family; and/or

(ii) an extract obtained from or obtainable from a plant of the Amaranthaceae family.

A food stabilising composition of the invention may comprise at least one plant derived inhibitor, wherein the at least one plant derived inhibitor comprises:

(a) an extract obtained from or obtainable from a plant of the Lythraceae family; and optionally

(b) (i) an extract obtained from or obtainable from a plant of the Lamiaceae family; and/or

(ii) An extract obtained or obtainable from a plant of the Amaranthaceae family.

For example, a food stabilising composition of the invention may comprise at least one plant derived inhibitor, wherein the at least one plant derived inhibitor comprises an extract obtained from or obtainable from a plant of the Lythraceae family.

The food stabilising composition may comprise from about 1% to about 100% of the at least one plant derived inhibitor as defined previously, such as from about 20% to about 80% or from about 40% to about 60% by weight of the composition.

In certain aspects, the food stabilising composition of the invention may consist of or consist essentially of the at least one plant derived inhibitor as defined above.

For example, the composition may consist of or consist essentially of at least one plant derived inhibitor obtained from or obtainable from at least one cereal, at least one pseudo-cereal, a plant of the Fabaceae family, a plant of the Lamiaceae family, a plant of the Malpighiaceae family, a plant of the Amaranthaceae family or a plant of the Lythraceae family or combinations thereof, or the food stabilising composition of the invention may consist of or consist essentially of at least one plant derived inhibitor obtained or obtainable from:

(a) an extract obtained from or obtainable from at least one cereal; and optionally

(b) (i) an extract obtained from or obtainable from a plant of the Lamiaceae family; and/or

(ii) an extract obtained from or obtainable from a plant of the Lythraceae family; and/or

(iii) an extract obtained from or obtainable from a plant of the Amaranthaceae family; or

(a) an extract obtained from or obtainable from at least one pseudo-cereal; and optionally

(b) (i) an extract obtained from or obtainable from a plant from the Lamiaceae family; and/or

(ii) an extract obtained from or obtainable from a plant of the family Lythraceae and/or

(iii) an extract obtained from or obtainable from a plant of the Amaranthaceae family; or

(a) an extract obtained from or obtainable from a plant of the Fabaceae family; and optionally

(b) (i) an extract obtained from or obtainable from a plant of the Lamiaceae family; and/or

(ii) an extract obtained from or obtainable from a plant of the Lythraceae family; and/or

(iii) an extract obtained from or obtainable from a plant of the Amaranthaceae family;

For example, an extract obtained from or obtainable from a plant of the Fabaceae family; and optionally an extract obtained from or obtainable from a plant of the Lamiaceae family.

or

(a) an extract obtained from or obtainable from a plant of the Lamiaceae family; and optionally

(b) (i) an extract obtained from or obtainable from a plant of the Malpighiaceae family; and/or

(ii) an extract obtained from or obtainable from a plant of the Amaranthaceae family.

For example, an extract obtained from or obtainable from a plant of the Lamiaceae family; and

(i) an extract obtained from or obtainable from a plant of the Fabaceae family; and/or (ii) an extract obtained from or obtainable from a plant of the Amaranthaceae family. or

(a) an extract obtained from or obtainable from a plant of the Lythraceae family; and optionally

(b) (i) an extract obtained from or obtainable from a plant of the Lamiaceae family; and/or

(ii) an extract obtained or obtainable from a plant of the Amaranthaceae family.

For example, an extract obtained from or obtainable from a plant of the Lythraceae family.

In an aspect of the invention, the food stabilising composition may comprise at least one plant derived inhibitor comprising an extract, extracts or juice obtained or obtainable from: (i) rosemary and spinach; (ii) rosemary and pea; (iii) pea; or (iv) pomegranate.

The term “stabilising” as used herein means reducing, inhibiting or preventing degradation, in particular reducing, inhibiting or preventing oxidation over a given period relative to the amount of oxidation that would have occurred in the absence of the stabilising composition. For example, a “stabilising composition” may reduce, inhibit or prevent oxidation by chelating transition metals, such as Cu²⁺ and Fe²⁺ and/or may provide free radical scavenging activity.

The term “cereal” as used herein refers to monocotyledonous or eudicotyledonous plants that are grown for their edible seeds. As used herein, cereals include plants selected from genera consisting of Oryza, Triticum, belonging to the family of Poaceae, and combinations thereof. For example, rice, wheat and maize/sweetcorn.

All references herein to an extract obtained from or obtainable from at least one cereal will typically refer to extracts obtained from or obtainable from the seeds or the juice of the at least one cereal. For example, extracts obtained from the hull of the seed or from the whole de-hulled seed of the at least one cereal. The seed may be germinated or un-germinated.

The term “pseudo-cereal” as used herein refers to eudicotyledonous plants that are grown for their edible seeds. As used herein, pseudo-cereals include plants selected from families consisting of Polygonaceae, Chenopodiceae, and Cannabaceae, and combinations thereof. For example, buckwheat, quince, chia, alfalfa, and hemp, and combinations thereof.

All references herein to an extract obtained from or obtainable from at least one pseudo-cereal will typically refer to extracts obtained from or obtainable from the seeds or the juice of the at least one pseudo-cereal. For example, extracts obtained from the hull of the seed of the at least one pseudo-cereal. The seed may be germinated or un-germinated.

Extracts obtained from at least one cereal or pseudo-cereal may be obtained from dry and/or ground parts of the plant as defined above. For example, dry and/or ground seeds from the cereal or pseudo-cereal may be used to obtain the extract.

All references herein to an extract obtained from or obtainable from a plant from the Fabaceae family, such as peas, will typically refer to extracts obtained from or obtainable from the fruit, seeds or the juice of the plant from the Fabaceae family. For example, extracts obtained from the seed. The seed may be germinated or un-germinated.

All references herein to an extract obtained from or obtainable from a plant from the Lamiaceae family (such as rosemary) will typically refer to extracts obtained from or obtainable from the leaves of the plant from the Lamiaceae family. The Lamiaceae extract may be deodorised and/or decolourised. For example, the Lamiaceae extract may have had all of the volatile oil compounds removed.

All references herein to an extract obtained from or obtainable from a plant from the Malpighiaceae family, such as acerola, will typically refer to extracts obtained from or obtainable from the juice of the plant. For example, extracts obtained from the juice of the fruit of the plant.

All references herein to an extract obtained from or obtainable from a plant from the Amaranthaceae family, such as spinach, will typically refer to extracts obtained from or obtainable from the aerial parts of the plant. For example, extracts obtained from the leaves or stems of the plant.

All references herein to an extract obtained from or obtainable from a plant from the Lythraceae family, such as pomegranate, will typically refer to extracts obtained from or obtainable from the skin of the plant fruit or seed, such as from the hull of the seed. For example, an extract obtained from the skin of the fruit. If the extract is obtained from a seed, the seed may be germinated or un-germinated.

In some aspects, the at least one plant derived inhibitor will have been extracted from the respective plants using water only. For example, the at least one plant derived inhibitor obtained from or obtainable from at least one plant selected from the group consisting of cereals, pseudo-cereals, the Fabaceae family, the Lamiaceae family, the Malpighiaceae family, the Amaranthaceae family and the Lythraceae family, and combinations thereof, such as the Fabaceae family, the Lamiaceae family, the Amaranthaceae family and the Lythraceae family, and combinations thereof, i.e. (i) rosemary and spinach; (ii) rosemary and pea; (iii) pea; or (iv) pomegranate, may have been extracted using water only. This extract may be referred to as the water extract.

In certain aspects, the water used to provide the extract may be acidic. For example, the pH of the water used to provide the extract may be from about 1 to about 6, or from about 2 to about 4, such as pH 3. This extract may be referred to as the acidic water extract.

In other aspects, the at least one plant derived inhibitor will have been extracted from the respective plants using alcohol, such as ethanol. For example, the at least one plant derived inhibitor obtained from or obtainable from at least one plant selected from the group consisting of cereals, pseudo-cereals, the Fabaceae family, the Lamiaceae family, the Malpighiaceae family, the Amaranthaceae family and the Lythraceae family, and combinations thereof, such as the Fabaceae family, the Lamiaceae family, the Amaranthaceae family and the Lythraceae family, and combinations thereof, i.e. (i) rosemary and spinach; (ii) rosemary and pea; (iii) pea; or (iv) pomegranate, may have been extracted using alcohol only, such as ethanol only. This extract may be referred to as the alcohol extract, such as the ethanol extract.

In other aspects, the at least one plant derived inhibitor will have been extracted from the respective plants using a mixture of alcohol and water, such as ethanol and water. For example, the at least one plant derived inhibitor obtained from or obtainable from at least one plant selected from the group consisting of cereals, pseudo-cereals, the Fabaceae family, the Lamiaceae family, the Malpighiaceae family, the Amaranthaceae family and the Lythraceae family, and combinations thereof, such as the Fabaceae family, the Lamiaceae family, the Amaranthaceae family and the Lythraceae family, and combinations thereof, i.e. (i) rosemary and spinach; (ii) rosemary and pea; (iii) pea; or (iv) pomegranate, may have been extracted using a mixture of alcohol and water, such as ethanol and water. This extract may be referred to as the hydro-alcoholic, such as the hydro-ethanolic extract.

In other aspects, the at least one plant derived inhibitor will have been extracted from the respective plants using an organic solvent that is not an alcohol, such as acetone. For example, the at least one plant derived inhibitor obtained from or obtainable from at least one plant selected from the group consisting of cereals, pseudo-cereals, the Fabaceae family, the Lamiaceae family, the Malpighiaceae family, the Amaranthaceae family and the Lythraceae family, and combinations thereof, such as the Fabaceae family, the Lamiaceae family, the Amaranthaceae family and the Lythraceae family, and combinations thereof, i.e. (i) rosemary and spinach; (ii) rosemary and pea; (iii) pea; or (iv) pomegranate, may have been extracted using an organic solvent, such as acetone. This extract may be referred to as the organic extract or the acetone extract.

Typically, when the at least one plant is a cereal or a pseudo-cereal, the at least one plant derived inhibitor may be extracted from the seed of the plant, such as from the hull of the seed of the plant. When the at least one plant is a plant of the Fabaceae family, the Lamiaceae family, the Malpighiaceae family, the Amaranthaceae family and the Lythraceae family, the at least one plant derived inhibitor may be extracted from the leaves and/or the fruit of the plant and/or the seed of the plant, such as from the fruit or seed of the plant.

Thus, the present invention provides a composition comprising a water, acidic water, hydro-alcoholic, alcohol or organic plant derived inhibitor obtained from or obtainable from at least one plant selected from the group consisting of cereals, pseudo-cereals, the Fabaceae family, the Lamiaceae family, the Malpighiaceae family, the Amaranthaceae family and the Lythraceae family, and combinations thereof, such as the Fabaceae family, the Lamiaceae family, the Amaranthaceae family and the Lythraceae family, and combinations thereof, i.e. (i) rosemary and spinach; (ii) rosemary and pea; (iii) pea; or (iv) pomegranate.

A food stabilising composition of the invention may comprise, consist or consist essentially of at least one plant derived inhibitor, wherein the at least one plant derived inhibitor comprises:

(a) a water, acidic water, hydro-alcoholic, alcohol or organic extract obtained from or obtainable from at least one cereal; and optionally

(b) (i) a water, acidic water, hydro-alcoholic, alcohol or organic extract obtained from or obtainable from a plant of the Lamiaceae family; and/or

(ii) a water, acidic water, hydro-alcoholic, alcohol or organic extract obtained from or obtainable from a plant of the Lythraceae family; and/or

(iii) a water, acidic water, hydro-alcoholic, alcohol or organic extract obtained from or obtainable from a plant of the Amaranthaceae family.

A food stabilising composition of the invention may comprise, consist or consist essentially of at least one plant derived inhibitor, wherein the at least one plant derived inhibitor comprises:

(a) a water, acidic water, hydro-alcoholic, alcohol or organic extract obtained from or obtainable from at least one pseudo-cereal; and optionally

(b) (i) a water, acidic water, hydro-alcoholic, alcohol or organic extract obtained from or obtainable from a plant from the Lamiaceae family; and/or

(ii) a water, acidic water, hydro-alcoholic, alcohol or organic extract obtained from or obtainable from a plant of the family Lythraceae and/or

(iii) a water, acidic water, hydro-alcoholic, alcohol or organic extract obtained from or obtainable from a plant of the Amaranthaceae family.

A food stabilising composition of the invention may comprise, consist or consist essentially of at least one plant derived inhibitor, wherein the at least one plant derived inhibitor comprises:

(a) a water, acidic water, hydro-alcoholic, alcohol or organic extract obtained from or obtainable from a plant of the Fabaceae family; and optionally

(b) (i) a water, acidic water, hydro-alcoholic, alcohol or organic extract obtained from or obtainable from a plant of the Lamiaceae family; and/or

(ii) a water, acidic water, hydro-alcoholic, alcohol or organic extract obtained from or obtainable from a plant of the Lythraceae family; and/or

(iii) a water, acidic water, hydro-alcoholic, alcohol or organic extract obtained from or obtainable from a plant of the Amaranthaceae family.

For example, a food stabilising composition of the invention may comprise, consist or consist essentially of at least one plant derived inhibitor, wherein the at least one plant derived inhibitor comprises:

(a) a water, acidic water, hydro-alcoholic, alcohol or organic extract obtained from or obtainable from a plant of the Fabaceae family; and optionally a water, acidic water, hydro-alcoholic, alcohol or organic extract obtained from or obtainable from a plant of the Lamiaceae family.

A food stabilising composition of the invention may comprise, consist or consist essentially of at least one plant derived inhibitor, wherein the at least one plant derived inhibitor comprises:

(a) a water, acidic water, hydro-alcoholic, alcohol or organic extract obtained from or obtainable from a plant of the Lamiaceae family; and optionally

(b) (i) a water, acidic water, hydro-alcoholic, alcohol or organic extract obtained from or obtainable from a plant of the Malpighiaceae family; and/or

(ii) a water, acidic water, hydro-alcoholic, alcohol or organic extract obtained from or obtainable from a plant of the Amaranthaceae family.

A food stabilising composition of the invention may comprise, consist or consist essentially of at least one plant derived inhibitor, wherein the at least one plant derived inhibitor comprises:

(a) a water, acidic water, hydro-alcoholic, alcohol or organic extract obtained from or obtainable from a plant of the Lamiaceae family; and

(b) (i) a water, acidic water, hydro-alcoholic, alcohol or organic extract obtained from or obtainable from a plant of the Fabaceae family; and/or

(ii) a water, acidic water, hydro-alcoholic, alcohol or organic extract obtained from or obtainable from a plant of the Amaranthaceae family.

A food stabilising composition of the invention may comprise, consist or consist essentially of at least one plant derived inhibitor, wherein the at least one plant derived inhibitor comprises:

(a) a water, acidic water, hydro-alcoholic, alcohol or organic extract obtained from or obtainable from a plant of the Lythraceae family; and optionally

(b) (i) a water, acidic water, hydro-alcoholic, alcohol or organic extract obtained from or obtainable from a plant of the Lamiaceae family; and/or

(ii) a water, acidic water, hydro-alcoholic, alcohol or organic extract obtained or obtainable from a plant of the Amaranthaceae family.

For example, a food stabilising composition of the invention may comprise, consist or consist essentially of at least one plant derived inhibitor, wherein the at least one plant derived inhibitor comprises a water, acidic water, hydro-alcoholic, alcohol or organic extract obtained from or obtainable from a plant of the Lythraceae family.

Optionally, the composition of the invention may comprise, consist or consist essential of the extract combination(s) defined above and a carrier.

Suitable carriers include inert solid diluents or fillers, sterile aqueous solutions and various organic solvents. Examples of solid carriers are lactose, terra alba, sucrose, cyclodextrin, maltodextrin, dextrin, talc, gelatine, agar, pectin, acacia, magnesium stearate, magnesium hydroxide; stearic acid, arabic gum, modified starch and lower alkyl ethers of cellulose, saccharose, silicon dioxide. Examples of liquid carriers are syrup, vegetables oils, phospholipids, fatty acids, fatty acid amines, polyoxyethylene and water. Moreover, the carrier or diluent may include any sustained release material known in the art, such as glyceryl monostearate or glyceryl distearate, alone or mixed with a wax.

The term “carrier” as used herein, may refer to a natural product or a product originating from nature that has been transformed or modified so that it is distinct from the natural product from which it originated.

A preferred carrier is maltodextrin.

When we use the term “consisting essentially of” or “consists essentially of” we mean that the composition or extract or juice being described must contain the listed ingredient(s) and may also contain small (for example up to 2% by weight, or up to 1% or up to 0.1% or 0.01% by weight) of other ingredients provided that any additional ingredients do not affect the essential properties of the composition or extract. When we use the term “consisting of” we mean that the composition being described must contain the listed ingredient(s) only. These terms can be applied in an analogous manner to processes, methods and uses.

As will be appreciated by the person skilled in the art, as used herein the term “obtainable from” means that the extract may be obtained from a plant or may be isolated from the plant, or may be obtained from an alternative source, for example by chemical synthesis or enzymatic production. Whereas the term “obtained” as used herein, means that the extract is directly derived from the plant source.

The term “cereal” as used herein refers to monocotyledonous or eudicotyledonous plants that are grown for their edible seeds. As used herein, cereals include plants belonging to the family Poaceae, including those selected from the genera consisting of Oryza, Triticum, and combinations thereof. For example, rice, wheat and maize/sweetcorn and combinations thereof.

Typically, in the composition of the invention the at least one pseudo-cereal is selected from the Polygonaceae, Chenopodiceae, and Cannabaceae families. For example, buckwheat, quinoa, chia, alfalfa, and hemp and combinations thereof.

Typically, in the composition of the invention, the at least one plant of the Lamiaceae family is typically rosemary and/or the at least one plant of the Lythraceae family is typically pomegranate and/or the at least one plant of the Amaranthaceae family is spinach.

Typically, in the composition of the invention, the at least one plant of the Malpighiaceae family is acerola.

Typically, in the composition of the invention, the at least one plant of the Fabaceae family is pea.

The food stabilising composition of the invention may comprise at least one plant derived inhibitor of fatty acid oxidation, wherein the at least one plant derived inhibitors is an extract or extracts obtained from or obtainable from:
Rice;
Rice and rosemary;
Rice and pomegranate;
Rice and spinach;
Buckwheat;
Buckwheat and rosemary;
Buckwheat and pomegranate;
Buckwheat and spinach;
Quinoa;
Quinoa and rosemary;
Quinoa and pomegranate;
Quinoa and spinach;
Quinoa and buckwheat;
Alfalfa;
Alfalfa and rosemary;
Alfalfa and pomegranate;
Alfalfa and spinach;
Hemp;
Hemp and rosemary;
Hemp and pomegranate;
Hemp and spinach;
Acerola;
Acerola and rosemary;
Acerola and pomegranate;
Acerola and spinach;
Acerola and pea;
Pomegranate;
Pomegranate and rosemary;
Pomegranate and spinach;
Pomegranate and peas;
Spinach;
Spinach and rosemary;
Peas
Peas and rosemary;
Peas and spinach.

Preferably, the food stabilising composition of the invention may comprise at least one plant derived inhibitor of fatty acid oxidation, wherein the at least one plant derived inhibitors is an extract or extracts obtained from or obtainable from
rosemary and spinach;
rosemary and pea;
pea; or
pomegranate.

For the avoidance of doubt, preferences, options, particular features and the like indicated for a given aspect, feature or parameter of the invention should, unless the context indicates otherwise, be regarded as having been disclosed in combination with any and all other preferences, option, particular features and the like as indicated for the same or other aspects, features and parameters of the invention.

The extract obtained or obtainable from the at least one cereal may contain from about 0.1% to about 10% organic acids by weight of the extract, such as from about 0.5% to about 5% organic acids. The organic acids may typically be phytic acid, which may be present in an amount from about 0.5% to about 5% by weight of the extract

The extract obtained from or obtainable from the at least one pseudo-cereal may contain at least about 0.1% polyphenol compounds by weight of the extract (determined by Folin Ciocalteu). For example, from about 0.1% to about 30%, or from about 0.5% to about 20% or from about 1% to about 10% polyphenol compounds by weight of the extract and/or the extract obtained from or obtainable from the at least one pseudo-cereal may contain less than about 5% citric acid by weight of the extract. For example, from about 0.01% to about 5%, or from about 1% to about 3% citric acid by weight of the extract.

Other compounds may also be present in the extract obtained from or obtainable from the at least one pseudo-cereal. Other compounds that may be present include, but are not limited to, oxalic acid, phytic acid, flavonoids, saponin, proanthcyanidins (PAC) and flavan-3-ol.

For example, the composition comprising an extract obtained from or obtainable from at least one pseudo-cereal may comprise from about 0.01% to about 5% oxalic acid, from about 0.1% to about 5% citric acid, from about 0.1% to about 10% polyphenol, from about 0.01% to about 1% flavonoids, from about 0.1% to about 5% PAC by weight of the extract.

The extract obtained from or obtainable from a plant of the Lamiaceae family may contain phenolic diterpenes in an amount of at least 1% by weight of the extract. For example, the extract obtained from or obtainable from a plant of the Lamiaceae family may contain phenolic diterpenes in an amount of from about 1% to about 95% by weight, such as from about 2.5% to about 90% by weight, from about 5% to about 85% by weight, from about 10% to about 80% by weight, from about 15% to about 60% by weight, from about 20% to about 50% by weight, from about 25% to about 40% by weight, such as from about 1% to about 30% by weight, from about 5% to about 20% by weight, from about 10% to about 15% by weight or from about 1% to about 5% by weight.

The extract obtained from or obtainable from a plant of the Lamiaceae family may be a phenolic diterpene, such as carnosic acid. For example, the extract obtained from or obtainable from a plant of the Lamiaceae family may comprise carnosic acid in an amount of at least 1% by weight of the extract. For example, the extract obtained from or obtainable from a plant of the Lamiaceae family may contain carnosic acid in an amount of from about 1% to about 95% by weight, such as from about 2.5% to about 90% by weight, from about 5% to about 85% by weight, from about 10% to about 80% by weight, from about 15% to about 60% by weight, from about 20% to about 50% by weight, from about 25% to about 40% by weight, such as from about 1% to about 30% by weight, from about 5% to about 20% by weight, from about 10% to about 15% by weight or from about 1% to about 5% by weight, e.g. from about 15% to about 30% by weight of the extract or from about 40% to about 65% by weight of the extract.

Where the at least one plant derived inhibitor is combined with a carrier, the relative proportions of the components will be reduced accordingly. For example, in some aspects, the amount of carnosic acid may be from about 1% to about 10%, such as from about 2% to about 6% or 5% by weight of the extract.

The extract obtained from or obtainable from a plant of the Lamiaceae family may also comprise carnosol and 12-O-methylcarnosic acid. For example, the extract obtained from or obtainable from a plant of the Lamiaceae family may comprise or contain from about 15% to about 30% by weight carnosic acid and from about 1% to about 3% by weight carnosol or the extract obtained from or obtainable from a plant of the Lamiaceae family may comprise or contain from about 40% to about 65% by weight carnosic acid, from about 2% to about 10% carnosol and from about 2% to about 10% by weight 12-O-methylcarnosic acid.

The extract obtained from or obtainable from a plant of the Amaranthaceae family, such as spinach, may contain at least about 0.1% polyphenol compounds by weight of the extract (determined by Folin Ciocalteu). For example, from about 0.1% to about 20%, or from about 0.5% to about 10% polyphenol compounds by weight of the extract and/or the extract obtained from or obtainable from a plant of the Amaranthaceae family may contain less than about 5% citric acid by weight of the extract. For example, from about 0.01% to about 5%, or from about 1% to about 3% citric acid by weight of the extract.

Other compounds may also be present in the extract obtained from or obtainable from a plant of the Amaranthaceae family. Other compounds that may be present include, but are not limited to, oxalic acid, phytic acid, proteins and sugars.

For example, the composition comprising an extract obtained from or obtainable from a plant of the Amaranthaceae family may comprise from about 0.01% to about 10% oxalic acid, from about 0.1% to about 5% citric acid, from about 0.1% to about 10% polyphenol, from about 1% to about 25% proteins (determined by Kjeldahl method) and from about 5% to about 35% sugars (determined by RID CQ-MO-286 vs ionic) by weight of the extract.

The extract obtained from or obtainable from a plant of the Fabaceae family, such as pea, may contain at least about 0.1% polyphenol compounds by weight of the extract (determined by Folin Ciocalteu). For example, from about 0.1% to about 10%, or from about 0.2% to about 5% polyphenol compounds by weight of the extract and/or the extract obtained from or obtainable from a plant of the Fabaceae family may contain less than about 10% citric acid by weight of the extract. For example, from about 0.01% to about 10%, or from about 1% to about 8% citric acid by weight of the extract.

Other compounds may also be present in the extract obtained from or obtainable from a plant of the Fabaceae family. Other compounds that may be present include, but are not limited to, phytic acid, proteins and sugars.

For example, the composition comprising an extract obtained from or obtainable from a plant of the Fabaceae family may comprise from about 0.1% to about 10% citric acid, from about 0.1% to about 5% polyphenol, from about 1% to about 15% proteins (determined by Kjeldahl method) and from about 10% to about 60% sugars (determined by RID CQ-MO-286 vs ionic) by weight of the extract.

The extract obtained or obtainable from a plant of the Lythraceae family, such as pomegranate, may contain ellagic acid and punicalagin. The amount of ellagic acid may be from about 0.5% to about 20% by weight of the extract, such as from about 1% to about 15% by weight of the extract. The amount of punicalagins may be from about 0.5% to about 15% by weight of the extract, such as from about 1% to about 10% by weight of the extract. Depending on whether the extract is in solid or liquid form, the amount of ellagic acid and punicalagins may be different. In liquid form, the amount of ellagic acid may be from about from about 5% to about 15% and the amount of punicalagins may be from about 2.5% to about 10% by weight of the extract. In solid form, such as powder, the amount of ellagic acid may be from about from about 0.5% to about 5% and the amount of punicalagins may be from about 0.5% to about 10% by weight of the extract.

The extract obtained or obtainable from a plant of the Malpighiaceae family, such as acerola, may comprise ascorbic acid. The amount of ascorbic acid may be from about 5% to about 50% by weight of the extract. When the extract is obtained or obtainable from dried juice, the extract may comprise from about 15% to about 35% ascorbic acid by weight of the extract.

Unless otherwise stated herein, the weight percentages listed are based on the total weight of the extract, for example the total weight of the dry extract.

The term “about” as used herein, e.g. when referring to a measurable value (such as an amount of weight of a particular component in the composition or reaction mixture), refers to variations of ±20%, ±10%, ±5%, ±1%, ±0.5%, or particularly, ±0.1%, of the specified amount.

In a food stabilising composition of the invention wherein the at least one plant derived inhibitor is a combination of more than one plant extract, juice or product, such as two different plant extracts, the weight percentage ratio of the two extracts may be from about 1:99 to about 99:1, such as from about 50:1 to about 1:50, or about 25:1 to about 1:25 or from about 5:1 to about 1:5, such as 1:1.

For example, in the food stabilising composition of the invention, the at least one plant derived inhibitor maybe the combination of an extract, juice or product obtained or obtainable from two different plants selected from the group consisting of the Fabaceae family, the Lamiaceae family, the Amaranthaceae family and the Lythraceae family, wherein the weight ratio of each extract, juice or product is from about 1:99 to about 99:1, such as from about 50:1 to about 1:50, or about 25:1 to about 1:25 or from about 5:1 to about 1:5, such as 1:1.

In a food stabilising composition of the invention, wherein the plant derived inhibitor is an extract obtained from or obtainable from at least one pseudo-cereal and an extract obtained from or obtainable from a plant of the Lamiaceae family the weight percentage ratio of the two extracts may be from about 10:1 to about 1:10, such as from about 5:1 to about 1:5.

In a food stabilising composition of the invention, wherein the plant derived inhibitor is dried juice obtained from or obtainable from a plant of the Malpighiaceae family and an extract obtained from or obtainable from a plant of the Lamiaceae family the weight percentage ratio of the two extracts may be from about 5:1 to about 1:5, such as from about 2.5:1 to about 1:2.5.

In a food stabilising composition of the invention, wherein the plant derived inhibitor is an extract obtained from or obtainable from a plant of the Fabaceae family and an extract obtained from or obtainable from a plant of the Lamiaceae family the weight percentage ratio of the two extracts may be from about 5:1 to about 1:5, such as from about 2.5:1 to about 1:2.5 or 1:1.

In a food stabilising composition of the invention, wherein the plant derived inhibitor is an extract obtained from or obtainable from a plant of the Lythraceae family and an extract obtained from or obtainable from a plant of the Lamiaceae family the weight percentage ratio of the two extracts may be from about 30:1 to about 1:30, such as from about 20:1 to about 1:20.

In a food stabilising composition of the invention, wherein the plant derived inhibitor is an extract obtained from or obtainable from a plant of the Amaranthaceae family and an extract obtained from or obtainable from a plant of the Lamiaceae family the weight percentage ratio of the two extracts may be from about 10:1 to about 1:10, such as from about 5:1 to about 1:5.

In a food stabilising composition of the invention, wherein the plant derived inhibitor is an extract obtained from or obtainable from a plant of the Amaranthaceae family and an extract obtained from or obtainable from a plant of the Lythraceae family the weight percentage ratio of the two extracts may be from about 30:1 to about 1:30, such as from about 20:1 to about 1:20.

The food stabilising composition of the invention may in use inhibit or prevent the conversion of polyunsaturated fatty acid (PUFA) oils to 2,4-heptadienal and/or 2,4-decadienal. For example, the composition of the invention may inhibit the formation of 2,4-heptadienal in a foodstuff, such as mayonnaise, to less than 15,000 ppb, for example, less than 10,000 ppb after 15 or 20 days accelerated aging at 50° C.

The skilled person will understand that the composition of the invention may typically be provided in solid form, but may be provided in liquid form depending on the type of plant or the type of extraction process used to obtain the extract. By solid form, it is included that the composition may be provided as powder, an amorphous solid, or as a crystalline or part-crystalline solid.

The dried extract may be mixed with a liquid carrier before use.

As discussed above, the food stabilising composition of the invention may comprise a carrier, such as maltodextrin. If a carrier is present in the composition of the invention, typically the carrier may be present in an amount of from about 1% to about 50%, such as from about 10% to about 30% or 25% by weight of the composition or extract.

Process for Obtaining the Stabilising Composition

The food stabilising composition comprising at least one plant derived inhibitor of fatty acid oxidation may be obtained by or is obtainable by the extraction, juice expression and isolation processes as generally described herein below, or routine modifications thereof.

The food stabilising composition of the invention comprising at least one plant derived inhibitor of fatty acid oxidation may be obtained by or obtainable by a process comprising the following steps:

(i) contacting at least part of at least one plant selected from the group consisting of cereals, pseudo-cereals, the Fabaceae family, the Lamiaceae family, the Malpighiaceae family, the Amaranthaceae family and the Lythraceae family, and combinations thereof, (such as the Fabaceae family, the Lamiaceae family, the Amaranthaceae family and the Lythraceae family, and combinations and mixtures thereof, i.e. (i) rosemary and spinach;

(ii) rosemary and pea; (iii) pea; or (iv) pomegranate) i.e. grinding the whole seed or the hull of the seed of the respective plant or grinding the plant itself, such as the leaves and/or the stem of the plant with a solvent; and

(ii) removing the solvent.

Optionally, the plant may be ground before being contacted with a solvent.

Wherein the at least one plant derived inhibitor is obtained from a dried juice, the dried juices are obtained from concentrated fruit juices. Such as concentrated fruit juices supplemented with carbonates and/or hydroxyls of different salts.

For example, the food stabilising composition of the invention comprising at least one plant derived inhibitor of fatty acid oxidation may also be obtained by or obtainable by a process comprising the following steps:

a. crushing the crushing the at least one plant or fruit of the at least one plant selected from the group consisting of cereals, pseudo-cereals, the Fabaceae family, the Lamiaceae family, the Malpighiaceae family, the Amaranthaceae family and the Lythraceae family or combinations thereof (such as the Fabaceae family, the Lamiaceae family, the Amaranthaceae family and the Lythraceae family, and combinations and mixtures thereof, i.e. (i) rosemary and spinach; (ii) rosemary and pea; (iii) pea; or (iv) pomegranate) to obtain the juice to obtain the juice; and

b. evaporating the liquid from the juice or concentrating juice in presence of carbonates/and or hydroxyls and their corresponding salts.

This method may typically be used to provide the food stabilising composition of the invention comprising at least one plant derived inhibitor obtained from or obtainable from the fruit of at least one plant of the Malpighiaceae family, such as acerola.

It is to be understood, that if the stabilising composition of the invention contains extracts from two or more plant species as previously defined, the extracts may be prepared using the above process together or may each be prepared using the above process independently then combined with any additional optional ingredients, such as a carrier (i.e. maltodextrin) in the required ratios to form the food stabilising composition of the invention.

Thus, the process of the invention includes a step of optionally combining the obtained extract with another extract.

When the at least one plant selected from the group consisting of cereals, pseudo-cereals, the Fabaceae family, the Lamiaceae family, the Malpighiaceae family, the Amaranthaceae family and the Lythraceae family, and combinations thereof (such as the Fabaceae family, the Lamiaceae family, the Amaranthaceae family and the Lythraceae family, and combinations and mixtures thereof, i.e. (i) rosemary and spinach; (ii) rosemary and pea; (iii) pea; or (iv) pomegranate) is ground before step (i), the plant, for example the seed, skin or hull of the plant or seed, may be ground into granules with a particle size in a range from about 0.1 mm to about 20 mm, such as from about 0.5 mm to about 10mm, or from about 1 mm to 5 mm, for example, 2 mm. Optionally, the plant may be dried before grinding. The grinding may be done using methods known in the art, such as milling or using a pestle and mortar.

Solvents that may be used in step (i) include alcohols, such as methanol and ethanol, water (including water that has been acidified), alcohol/water mixtures (such as mixtures of ethanol and water) and acetone. For example, the extraction solvents may be acetone, water, acidified water, a water-alcohol mixture (from about 1% to about 99% alcohol in water, such as from about 10% to about 50% alcohol in water, e.g. about 30% alcohol in water), or alcohol. Particular alcohols that may be mentioned include methanol and ethanol.

Typically, in the process of the invention, water (when present) is at an acidic pH. For example, the water is at a pH of from about 1 to about 5, e.g. about pH 3. The water can be acidified by techniques known in the art. For example, the water may be acidified with 20% nitric acid, phosphoric acid or citric acid.

Typically, in the process of the invention, where the stabilising composition of the invention comprises an extract obtained from or obtainable from a plant of the Lamiaceae family the extraction solvent is acetone.

Typically, in the process of the invention, where the stabilising composition of the invention comprises an extract obtained from or obtainable from a plant of the Lythraceae family the extraction solvent is ethanol or aqueous ethanol.

Typically, in the process of the invention, where the stabilising composition of the invention comprises an extract obtained from or obtainable from a plant of the Malpighiaceae family the extract is provided by obtaining juice from the plant (such as from the fruit) and removing to liquid from the juice or optionally dried in presence of carbonates or hydroxyls.

Typically, in the process of the invention, where the stabilising composition of the invention comprises an extract obtained from or obtainable from a plant of the Amaranthaceae family the extraction solvent is acidic water.

Typically, in the process of the invention, where the stabilising composition of the invention comprises an extract obtained from or obtainable from at least one cereal or pseudo-cereal, the extraction solvent is water, acidic water, ethanol or a hydro-ethanolic solvent.

Step (ii) may be performed at a temperature in a range of from about 20° C. to about 200° C. For example, the temperature for of step (ii) may be in a range of from about 40° C. to about 100° C., such as 50° C., 55° C., 60° C., 65° C. or 70° C.

Alternatively, step (ii) may be performed at the temperature at which the solvent will reflux.

Any suitable extraction apparatus may be used. For example, the at least one plant selected from the group consisting of cereals, pseudo-cereals, the Fabaceae family, the Lamiaceae family, the Malpighiaceae family, the Amaranthaceae family and the Lythraceae family, and combinations thereof (such as the Fabaceae family, the Lamiaceae family, the Amaranthaceae family and the Lythraceae family, and combinations and mixtures thereof, i.e. (i) rosemary and spinach; (ii) rosemary and pea; (iii) pea; or (iv) pomegranate) may be extracted using Soxhlet apparatus.

Typically, the ratio of plant material to solvent mixture used in the extraction process varies from about 1:1 to about 1:10 on a gram to millilitre basis, such as from about 1:3 to about 1:8. For example, a 10M ratio may be used.

The incubation period (i.e. the period during which the plant material is in contact with the solvent (steps (ii) and (v))) is typically from about 2 hours to about 24 hours. Any un-dissolved plant material may be removed from the solvent, for example, by filtration, and re-dissolved in the solvent. The incubation period may then be repeated.

After the plant materials and solvent have been incubated in process step (ii), the solvent is separated from any un-dissolved plant material and the extracted composition is concentrated (i.e. the solvent is removed) until the extraction composition has a solid component. For example, until all the solvent has been removed and only solid extract remains.

A similar procedure is used in step b. where the juice is separated from solid plant material and then concentrated (i.e. the liquid in the juice is removed) until there is a solid component. For example, only solid extract remains.

Typically, in the process of the invention, at least 50%, such as 60%, 70%, 80%, 90%, 95% or 100% of the solvent and/or liquid is removed.

Typically, in the process of obtaining a food stabilising composition of the invention (i.e. steps (i) to (iii) as described herein above): the at least one plant selected from the group consisting of cereals, pseudo-cereals, the Fabaceae family, the Lamiaceae family, the Malpighiaceae family, the Amaranthaceae family and the Lythraceae family, and combinations thereof (such as the Fabaceae family, the Lamiaceae family, the Amaranthaceae family and the Lythraceae family, and combinations and mixtures thereof, i.e. (i) rosemary and spinach; (ii) rosemary and pea; (iii) pea; or (iv) pomegranate) are ground to particles having a diameter of from about 0.1 mm to 30 mm; contacted with a solvent (water, water at about pH 3, 70% water at about pH 3/30% ethanol 96° or acetone) and incubated at a temperature of from about 20° C. to about 100° C. for from about 2 hours to about 24 hours; the solvent is then removed to yield the solid extract.

For example, the food stabilising composition of the invention may be obtained by or is obtainable by the following processes:
the at least one plant selected from the group consisting of cereals, pseudo-cereals, the Fabaceae family, the Lamiaceae family, the Malpighiaceae family, the Amaranthaceae family and the Lythraceae family, and combinations thereof (such as the Fabaceae family, the Lamiaceae family, the Amaranthaceae family and the Lythraceae family, and combinations and mixtures thereof, i.e. (i) rosemary and spinach; (ii) rosemary and pea; (iii) pea; or (iv) pomegranate) is ground to particles of approximately 2 mm;
the ground particles are contacted with a solvent (water, water at acidic pH, 70% water 30% ethanol 96°, absolute ethanol or acetone)
any undissolved material is filtered from the solvent and re-dissolved in a solvent (water, water at acidic pH, 70% water 30% ethanol 96°, absolute ethanol or acetone)
any un-dissolved material is filtered from the solvent and the two solvent fractions are combined and the solvent evaporated;
the dry solid is then ground to form a fine particulate solid.

As noted previously, if the stabilising composition of the invention contains extracts from two or more plant species as previously defined, the extracts may be prepared using the above process together or may each be prepared using the above process independently then combined with any additional optional ingredients, such as a carrier (i.e. maltodextrin) in the required ratios to form the food stabilising composition of the invention.

For example, the at least one cereal, or the at least one pseudo-cereal, or the at least one plant of the Fabaceae family, or the at least one plant of the Lamiaceae family, or the at least one plant of the Malpighiaceae family, or the at least one plant of the Amaranthaceae family or the at least one plant of the Lythraceae family may be extracted individually and then combined to provide the stabilising composition of the invention.

After completion of the extraction process, the extract may be purified using a chromatographic process, if required.

The extract obtained from such processes may be substantially free of other plant material (e.g. free of plant cellulose).

As used herein, references to a material being “substantially free” of another material may refer to the material consisting of less than 1% by weight (e.g. less than 0.1%, such as less than 0.01% or less than 0.001%, by weight) of that other material.

The composition of the invention as described herein may comprise an extract or extracts obtained from (or obtainable by) a process as described herein.

Applications

A food stabilising composition of the invention may be utilised in any application in which the oxidation, inhibition or prevention of oxidation is required.

The use of a composition of the invention in foodstuffs, nutrition and health matrices/products or cosmetics matrices/products has been found to be particularly advantageous.

A composition of the invention may stabilise foodstuff, nutrition and health matrices/products or cosmetics matrices/products susceptible to oxidative degeneration by reducing, inhibiting or preventing the amount of oxidation over a given period relative to the amount of oxidation that would have occurred in the absence of the stabilising composition.

Thus, according to the present invention, there is provided a method for stabilising a foodstuff, nutrition and health matrices/products or cosmetics matrices/product, wherein the method comprises the step of contacting the foodstuff with a food stabilising composition as described herein. In this context, “contacting” includes incorporating a composition of the invention into a foodstuff.

There is also provided the use of a food stabilising composition as defined herein, for stabilising a foodstuff, nutrition and health matrices/product or cosmetics matrices/product.

“Stabilising a foodstuff, nutrition and health matrices/product or cosmetics matrices/product” includes reducing, inhibiting or preventing oxidation of the foodstuff, nutrition and health matrices/product or cosmetics matrices/product. For example, stabilising a foodstuff may mean may reducing, inhibiting or preventing oxidation of the foodstuff by chelating transition metals, such as Cu²⁺ and Fe²⁺ and/or providing free radical scavenging activity.

The food stabilising composition of the invention may in use inhibit or prevent the conversion of polyunsaturated fatty acid (PUFA) oils to 2,4-heptadienal and/or 2,4-decadienal. For example, the composition of the invention may inhibit the formation of 2,4-heptadienal in a foodstuff, such as mayonnaise, to less than 15,000 ppb, for example, less than 10,000 ppb after 15 or 20 days accelerated aging at 50° C.

The composition of the invention is particularly suitable for use in foodstuffs comprising an oil-in-water emulsion or which are oil-in-water emulsions, such as egg and oil based sauces, e.g. mayonnaise, hollandaise or béarnaise.

Typically, the foodstuff is substantially free of any EDTA. For example, the food stuff may contain less than about 5% EDTA or less than about 2.5% EDTA or less than about 75 ppm EDTA or no EDTA.

Foodstuff

The present invention further provides a foodstuff comprising a food stabilising composition as defined herein.

The compositions of the invention are suitable for use in a wide range of foodstuffs. Such foodstuff includes, but are not limited to, raw meat, cooked meat, raw poultry products, cooked poultry products, raw seafood products, cooked seafood products, ready to eat meals, cooking sauces, such as pasta sauces and ketchups, table sauces, pasteurised and unpasteurised soups, salad dressings and other oil-in-water emulsions e.g. mayonnaise, water-in-oil emulsions, dairy products, bakery products, confectionary products, fruit products and foods with fat based or water containing filings. Preferably, the foodstuff comprises an oil-in-water-emulsion or is an oil-in-water emulsion. For example, the foodstuff may be a table sauce, such as an egg and oil based sauce, e.g. mayonnaise, hollandaise or béarnaise or a foodstuff comprising a table sauce, such as an egg and oil based sauce, e.g. mayonnaise, hollandaise or béarnaise.

Typically, the foodstuff is substantially free of any EDTA. For example, the food stuff may contain less than about 5% EDTA or less than about 2.5% EDTA or no EDTA.

The foodstuff typically contains the composition of the invention in an amount sufficient to stabilise the foodstuff, for example, to reduce, inhibit or prevent oxidation. Typically, the stabilising composition is present in the foodstuff in an amount from about 0.01% to about 10% by weight of the foodstuff. Such as from about 0.025% to about 5%, or from about 0.05% to about 2.5%. For example, the composition of the invention may be present in the foodstuff in an amount from about 5 ppm to about 20 pmm, such as from about 10 ppm.

The present invention provides a kit for stabilising a foodstuff. The kit comprising an extract obtained from or obtainable from at least one plant selected from the group consisting of cereals, pseudo-cereals, the Fabaceae family, the Lamiaceae family and the Malpighiaceae family, the Amaranthaceae family and the Lythraceae family or combinations thereof (such as the Fabaceae family, the Lamiaceae family, the Amaranthaceae family and the Lythraceae family, and combinations and mixtures thereof, i.e. (i) rosemary and spinach; (ii) rosemary and pea; (iii) pea; or (iv) pomegranate.).

For example, the kit may comprise:

(a) an extract obtained from or obtainable from at least one cereal; and optionally

(b) (i) an extract obtained from or obtainable from a plant of the Lamiaceae family; and/or

(ii) an extract obtained from or obtainable from a plant of the Lythraceae family; and/or

(iii) an extract obtained from or obtainable from a plant of the Amaranthaceae family, or

(a) an extract obtained from or obtainable from at least one pseudo-cereal; and optionally

(b) an extract obtained from or obtainable from a plant from the Lamiaceae family; and/or

(c) an extract obtained from or obtainable from a plant of the family Lythraceae, or

(a) an extract obtained from or obtainable from a plant of the Fabaceae family; and optionally

(b) (i) an extract obtained from or obtainable from a plant of the Lamiaceae family; and/or

(ii) an extract obtained from or obtainable from a plant of the Lythraceae family; and/or

(iii) an extract obtained from or obtainable from a plant of the Amaranthaceae family.

For example, an extract obtained from or obtainable from a plant of the Fabaceae family; and optionally an extract obtained from or obtainable from a plant of the Lamiaceae family,

or

(a) an extract obtained from or obtainable from a plant of the Lamiaceae family; and optionally

(b) (i) an extract obtained from or obtainable from a plant of the Malpighiaceae family; and/or

(iii) an extract obtained from or obtainable from a plant of the Amaranthaceae family.

For example, an extract obtained from or obtainable from a plant of the Lamiaceae family; and an extract or juice obtained from or obtainable from a plant of the Fabaceae family; and/or an extract obtained from or obtainable from a plant of the Amaranthaceae family,

or

(a) an extract obtained from or obtainable from a plant of the Lythraceae family; and optionally

(b) an extract obtained from or obtainable from a plant from the Lamiaceae family.

For example, an extract obtained from or obtainable from a plant of the Lythraceae family.

In the kit, the extracts (a) and optionally (b) and/or (c) may be provided in the same or separate containers, optionally with instructions for admixing and/or contacting and/or use.

When the food stabilising composition of the invention is incorporated into a foodstuff, such as egg and oil based sauces, e.g. mayonnaise, hollandaise or béarnaise, as well as providing a stabilising effect by reducing, inhibiting or preventing the amount of oxidation over a given period relative to the amount of oxidation that would have occurred in the absence of the stabilising composition, the composition of the invention should not adversely affect the colour of the foodstuff in which it has been incorporated.

Therefore, it is an object of the invention to provide a stabilising composition that achieves the desired stabilising effect and additionally, can be incorporated into a foodstuff, such as egg and oil based sauces, e.g. mayonnaise, hollandaise or béarnaise with no identifiable or a minimal change in the colour or taste of the foodstuff, such that the change would be unacceptable to the consumer.

Preparation of Foodstuff

The present invention provides a method of preparing an oil-in-water emulsion foodstuff comprising the food stabilising composition of the invention comprising the steps of: mixing a first aqueous phase, optionally with a food stabilising composition of the invention;

(ii) adding oil to the product obtained in step (i), optionally with a food stabilising composition of the invention; and

(iii) adding at least one further aqueous phase to the product obtained in step (ii).

The first aqueous phase may typically comprise water and egg yolk.

The at least one further aqueous phase may typically comprise vinegar.

If the food stabilising composition of the invention is added in step (i), typically the food stabilising composition of the invention is not added in step (ii) and vice versa. However, in certain aspects, the food stabilising composition of the invention may be added in both steps (i) and (ii).

For example, the oil-water emulsion, such as a mayonnaise, may be prepared by:

(a) Mixing water, egg yolk, sorbate and the food stablising composition of the invention together (which may be pre-solubilised into the water);

(b) Adding to the water phase the following mix: (Cemtex 12688+Lygomme KCT58)/oil ratio 1/3. And mixing for 1 minute until it becomes viscous;

(c) Adding oil slowly to the water phase with a vigorous agitation. And at ⅔ of the oil addition, adding the vinegar and salt, then adding the remaining oil and mixing for 1 minute. (d) Filling a 43 ml glass jar with 10 g of the oil-in-water emulsion (mayonnaise).

### BRIEF DESCRIPTION OF THE FIGURES

FIG. 1 depicts the oxidative stability of the mayonnaises prepared in Example 1 obtained by measuring the formation of 2,4-heptadienal (ppb) over a 50 day accelerated aging test.

FIG. 2 depicts the oxidative stability of the mayonnaises prepared in Example 2 obtained by measuring the formation of 2,4-heptadienal (ppb) over a 50 day accelerated aging test.

FIG. 3 depicts the oxidative stability of the mayonnaises prepared in Example 3 obtained by measuring the formation of 2,4-heptadienal (ppb) over a 50 day accelerated aging test.

FIG. 4 depicts the oxidative stability of the mayonnaises prepared in Example 4 obtained by measuring the formation of 2,4-heptadienal (ppb) over a 50 day accelerated aging test.

FIG. 5 depicts the oxidative stability of the mayonnaises prepared in Example 5 obtained by measuring the formation of 2,4-heptadienal (ppb) over a 50 day accelerated aging test.

FIG. 6 depicts the oxidative stability of the mayonnaises prepared in Example 6 obtained by measuring the formation of 2,4-heptadienal (ppb) over a 50 day accelerated aging test.

FIG. 7 depicts the oxidative stability of the mayonnaises prepared in Example 7 obtained by measuring the formation of 2,4-heptadienal (ppb) over a 50 day accelerated aging test.

FIG. 8 depicts the oxidative stability of the mayonnaises prepared in Example 8 obtained by measuring the formation of 2,4-heptadienal (ppb) over a 50 day accelerated aging test.

FIG. 9 depicts the oxidative stability of the mayonnaises prepared in Example 9 obtained by measuring the formation of 2,4-heptadienal (ppb) over a 50 day accelerated aging test.

FIG. 10 depicts the oxidative stability of the mayonnaises prepared in Example 10 obtained by measuring the formation of 2,4-heptadienal (ppb) over a 50 day accelerated aging test.

FIG. 11 depicts the oxidative stability of the mayonnaises prepared in Example 11 obtained by measuring the formation of 2,4-heptadienal (ppb) over a 50 day accelerated aging test.

FIG. 12 depicts the oxidative stability of the mayonnaises prepared in Example 12 obtained by measuring the formation of 2,4-heptadienal (ppb) over a 50 day accelerated aging test.

FIG. 13 depicts the oxidative stability of a mayonnaise comprising 0.035% rosemary extract and 0.05% acerola extract obtained by measuring the formation of 2,4-heptadienal (ppb) over a 50 day accelerated aging test.

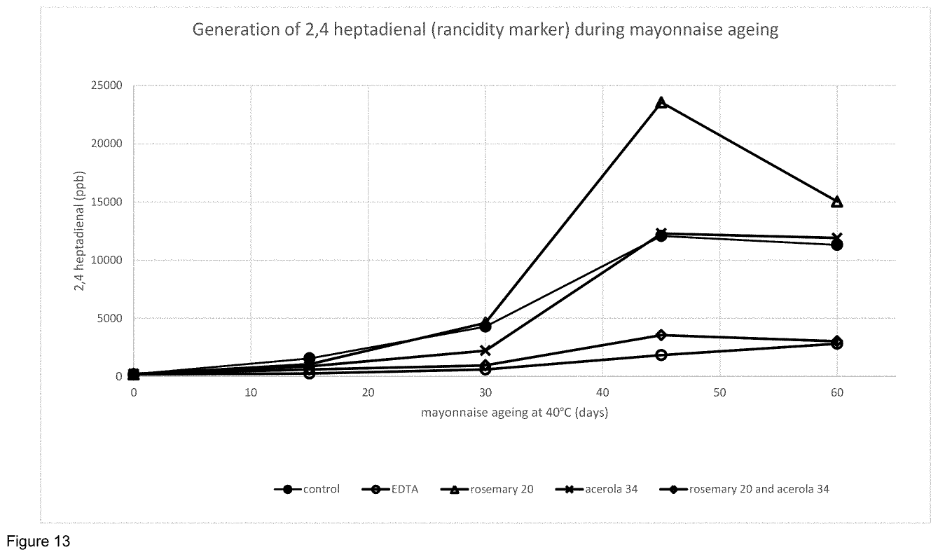

FIG. 14 depicts the oxidative stability of a mayonnaise comprising 0.4% buckwheat 25D extract and 1% rosemary (MPG/P80) extract obtained by measuring the formation of 2,4-heptadienal (ppb) over a 50 day accelerated aging test.

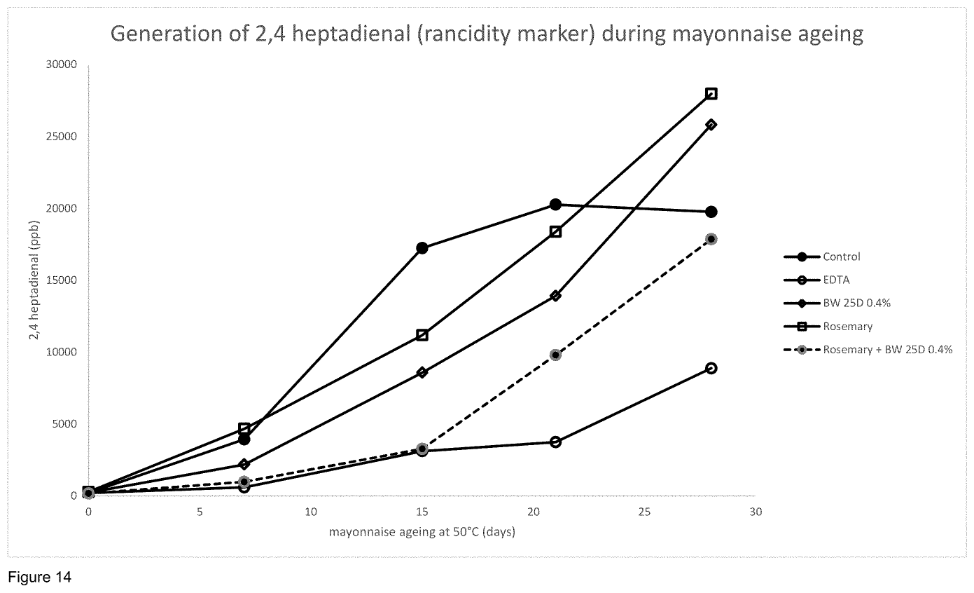

FIG. 15 depicts the oxidative stability of a mayonnaise comprising 1% buckwheat extract obtained by measuring the formation of 2,4-heptadienal (ppb) over a 50 day accelerated aging test.

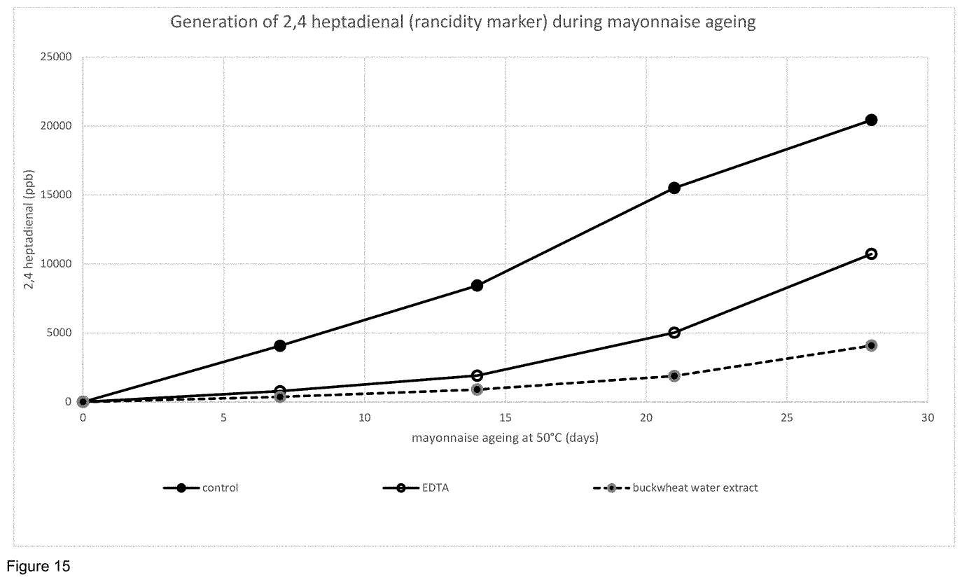

FIG. 16 depicts the oxidative stability of a mayonnaise comprising 0.047% rosemary extract and 0.066% pea extract obtained by measuring the formation of 2,4-heptadienal (ppb) over a 60 day aging test at room temperature.

FIG. 17 depicts the oxidative stability of a mayonnaise comprising 1% rosemary extract and 1% pea extract obtained by measuring the formation of 2,4-heptadienal (ppb) over a 50 day accelerated aging test.

FIG. 18 depicts the oxidative stability of a mayonnaise comprising 0.06% pea extract obtained by measuring the formation of 2,4-heptadienal (ppb) over a 50 day accelerated aging test.

FIG. 19 depicts the oxidative stability of a mayonnaise comprising 1% rosemary (MPG/P80) extract and 0.05% pomegranate extract obtained by measuring the formation of 2,4-heptadienal (ppb) over a 50 day accelerated aging test.

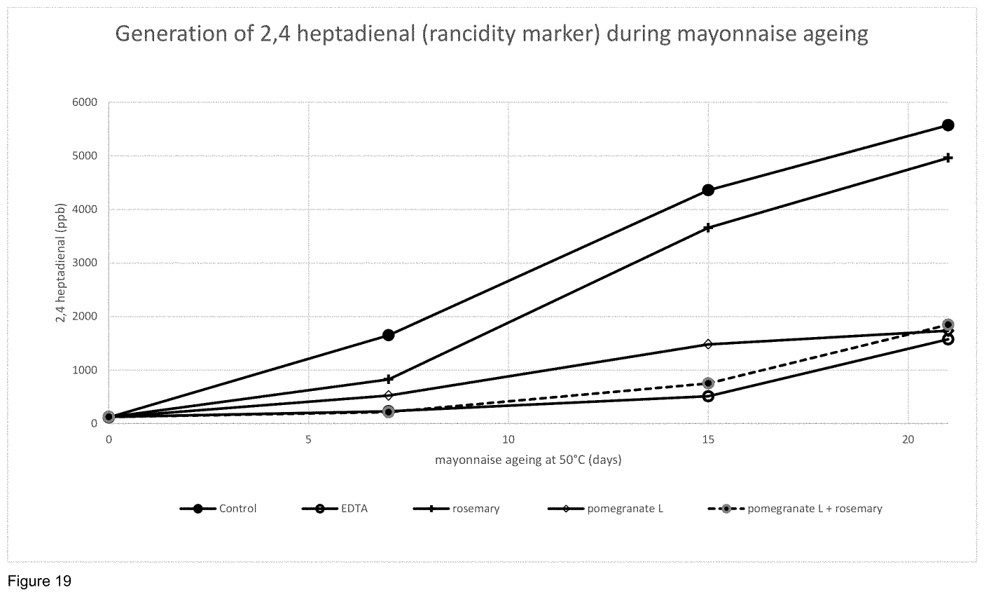

FIG. 20 depicts the oxidative stability of a mayonnaise comprising 0.05% pomegranate extract and 1% spinach extract obtained by measuring the formation of 2,4-heptadienal (ppb) over a 50 day accelerated aging test.

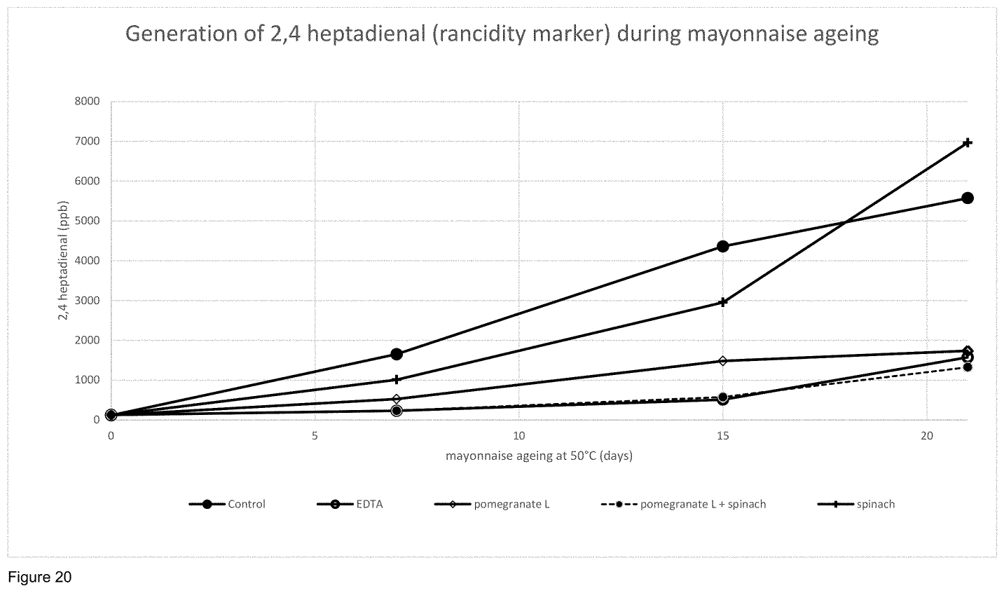

FIG. 21 depicts the oxidative stability of a mayonnaise comprising 0.05% pomegranate extract obtained by measuring the formation of 2,4-heptadienal (ppb) over a 50 day accelerated aging test.

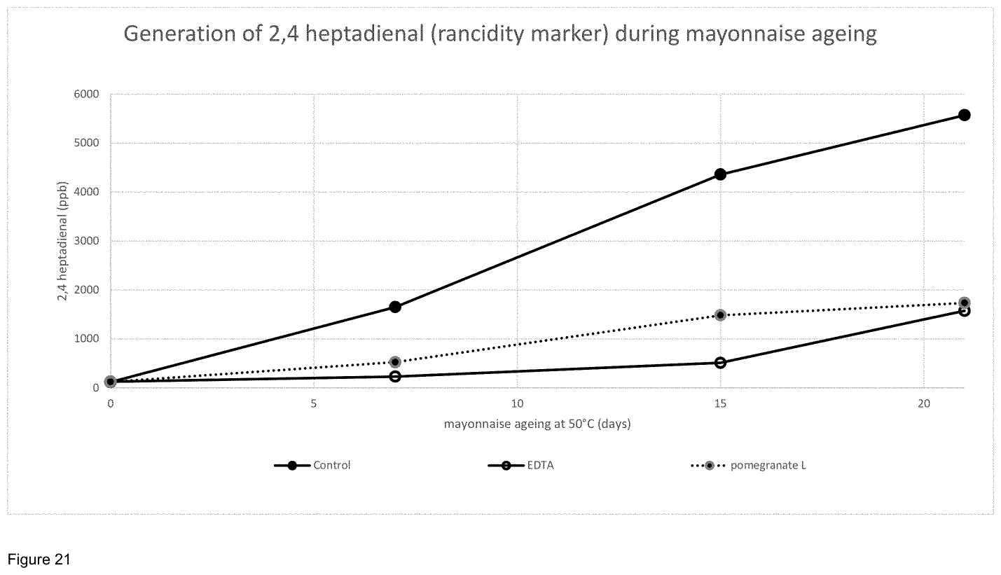

FIG. 22 depicts the oxidative stability of a mayonnaise comprising 1% rosemary (MPG/P80) extract and 1% quinoa extract obtained by measuring the formation of 2,4-heptadienal (ppb) over a 50 day accelerated aging test.

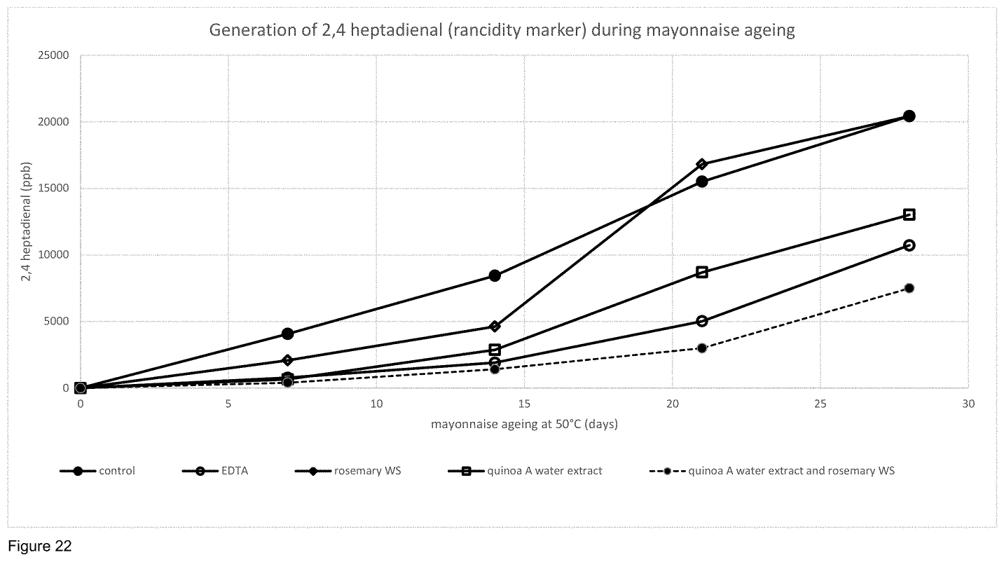

FIG. 23 depicts the oxidative stability of a mayonnaise comprising 1% quinoa extract obtained by measuring the formation of 2,4-heptadienal (ppb) over a 50 day accelerated aging test.

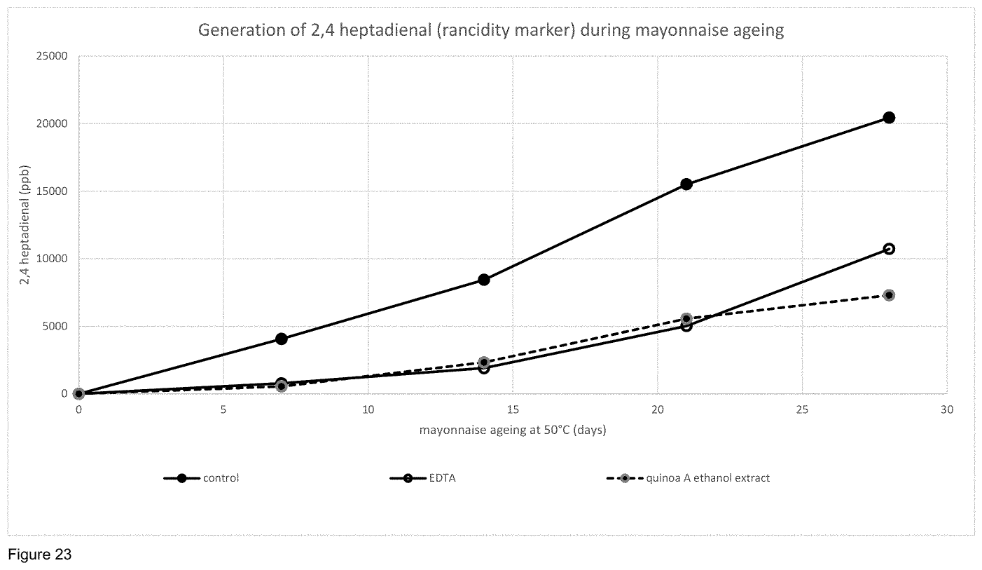

FIG. 24 depicts the oxidative stability of a mayonnaise comprising 1% rice hull extract obtained by measuring the formation of 2,4-heptadienal (ppb) over a 50 day accelerated aging test.

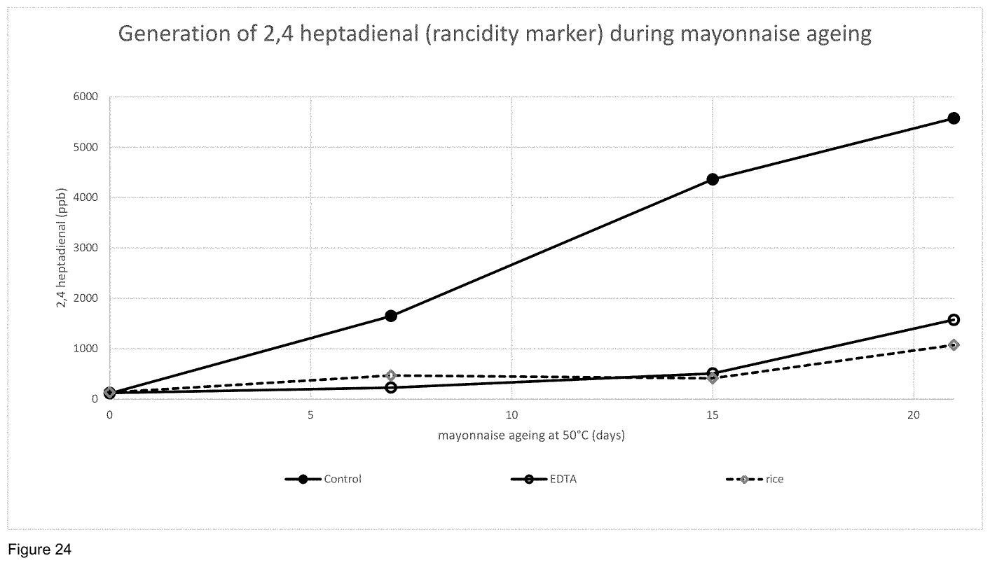

FIG. 25 depicts the oxidative stability of a mayonnaise comprising 0.124% spinach extract and 0.047% rosemary extract obtained by measuring the formation of 2,4-heptadienal (ppb) over a 60 day aging test at room temperature.

FIG. 26 depicts the oxidative stability of a mayonnaise comprising 0.124% spinach extract and 0.035% rosemary extract obtained by measuring the formation of 2,4-heptadienal (ppb) over a 50 day accelerated aging test.

FIG. 27 depicts a synergistic chelating effect between chia extract and quinoa.

FIG. 28 depicts the synergistic chelating effects seen between various combinations of plant extracts.

### EXAMPLES

The present invention will be further described with reference to the following, non-limiting examples.

General Procedures

In-Vitro Screening of Chelating Activity Using Ferrozine Test and Spectrometry

Preparation of Reagents

1) Buffer Solution at pH 4.5

Acetic acid solution (250 mL, 0.1M) was added slowly to a sodium acetate solution (500 mL, 0.1M) in a 1 L flask until the pH reached 4.5.

2) FeCl₂ Solution at 0.4 mM/L

FeCl₂,4H₂O (75.5 mg) was placed in a 100 mL volumetric flask. Enough distilled water was added to the flask so that the level of distilled water reached the 100 mL mark. A 1/10 dilution was then prepared using this solution.

3) Ferrozine at 0.5 mM/L

Ferrozine (246.3 mg) was placed in a 100 mL volumetric flask. Enough distilled water was added to the flask so that the level of distilled water reached the 100 mL mark. A 1/10 dilution was then prepared using this solution.

Preparation of Samples

Plant material extract (120 mg) was placed into a 20 mL volumetric vial. Buffer solution (6 mL at pH 4.5) was then added to the flask. The vial was then placed into an ultrasonic bath in order to homogenise the solution.

The resulting solution (Smother) was then used to prepare the following samples:

1) 1.125 mL Smother+0.375 mL of buffer solution at pH 4.5 to give a 15 mg/mL solution;

2) 0.75 mL Smother+0.75 mL of buffer solution at pH 4.5 to give a 10 mg/mL solution;

3) 0.375 mL Smother+1.125 mL of buffer solution at pH 4.5 to give a 5 mg/mL solution;

4) 0.187 mL Smother+1.310 mL of buffer solution at pH 4.5 to give a 2.5 mg/mL solution;

5) 0.094 mL Smother+1.406 mL of buffer solution at pH 4.5 to give a 1.25 mg/mL solution;

Two samples at each concentration were prepared resulting in a total of ten samples.

One of the samples at each concentration was used as a blank. Each blank was prepared by taking 1.5 mL of sample and adding 0.15 mL FeCl₂ and 0.3 mL of buffer solution at pH 4.5.

The remaining sample at each concentration was used as the test sample. The test sample was prepared by taking 0.5 mL sample and adding 0.15 mL FeCl₂ and 0.3 mL of ferrozine.

A control was prepared by adding 0.5 mL of buffer solution at pH 4.5 to 0.15 mL FeCl₂ and 0.3 mL of ferrozine.

Spectrophotometric Analysis Using Spectrophotometer SHIMADZU 1700 UV PROBE

After 25 minutes, each sample was centrifuged for 2 min 30 sec. The liquid was then decanted off and the absorbance of the liquid determined.

Data Processing

The percentage of bound Fe II (i.e. the % Fe chelated) was calculated as follows:

% Fe Chelated=(Absorbance of Control−Absorbance of Sample−Absorbance of Blank)/Absorbance of Control)×100

A regression curve of concentration versus % Fe(II) chelated was then drawn to enable the regression slope to be determined.

In-Vitro Free Radical Scavenging Activity Analysis Using DPPH Method Combined with HPTLC Finger Print

Preparation of Samples

Plant material extract was dissolved in water until a concentration of 20 mg/mL was reacted. The solution was then heated at 65° C., filtered using a 4.5 μm filter and then 4 μL of extract solution was placed on a plate in the HPTLC machine (CAMAG Automatic TLC Sampler 4 ATS4).

The plant material extract was migrated across the plate with 1-butanol:water:formic acid (8:3:2) and then revealed with DPPH solution (0.05%) diluted in methanol.

Data Processing

The results of the migration were observed with a densitometer to quantify the DPPH scavenging of the extract at 518 nm in negative signal mode (Lamp D2&W/Measurement type by remission and mode fluorescence).

Images of the plate were then acquired by CAMAG visualizer.

The presence of typical plant anti-oxidant was investigated by loading on the plate corresponding standard molecules.

A chromatogram was then obtained by densitometer by plotting the Rf value versus the Absorbance.

The sum of the area of all peaks relative to the active values of each extract was then calculated to give a total free radical scavenging activity.

### Example 1

### Buckwheat Extract 26 (BW26)

Preparation of Extract

Buckwheat hull was ground to particles of approximately 2 mm. The ground sample was then extracted two times for 2 hours at 65° C. with a mixture of 70% water at pH3 (acidified with nitric acid 20%)/30% Ethanol 96° which represented a 10M ratio of the mass plant. The mixture was then filtered. The liquid extract was evaporated with a rotary evaporator (Heidolph) with 25% of maltodextrin until dryness. The dry extract was then ground.

The ground extract was subjected to In-vitro screening of chelating activity and In-vitro free radical scavenging activity testing as described above. The results of these tests are shown in Table 1.

TABLE 1
results of ferrozine and DPPH tests for BW26

| Chelating activity | | | Free radical |
|---|---|---|---|
| | | % Fe (II) | scavenging activity |
| Slope | C (mg/mL) | chelated | Area 1 μL |
| 11 | 1 | 6.7 | 42803.9 |
| | 2.5 | 25.9 | |
| | 5 | 58.5 | |
| | 10 | 81.8 | |
| | 15 | 89.6 | |
| | 20 | 94.3 | |

As can be seen from Table 1, BW26 responded to the ferrozine test with a positive chelating activity with a slope at 11 and a % Fe (II) chelated at 1% equal to 81.8%. BW26 had also a positive free radical scavenging activity with an area of 42 803.9.

The buckwheat hull were also extracted using the same process but with tap water only. This extract had a slope at 11 and a % Fe(II) chelated at 1% equal to 83%. Thus, it had the same chelating activity as BW26.

The extract with tap water also had a positive free radical scavenging activity with an area of 18 597.

Preparation of the Mayonnaise

The aqueous phase I (20.69% (w/w) of water, 5% (w/w) of pasteurise egg yolk and 0.1% (w/w) of potassium sorbate), was mixed with an ultra Turax. Next, if included, the BW26 extract was mixed with the phase I. The aqueous phase II (0.2% (w/w) of Lygomme KCT 58 (comprising three types of starches, gelifiers, galactomannane (E410, E412, E417) and carraghenane (E407)), 0.5% (w/w) of Cemtex 12688 and 2.1% (w/w) of colza oil) was then added to the mixture. Once the mixture was homogenised, 67.9% (w/w) of colza oil was added slowly with a vigorous agitation. At ⅔ of the oil addition, the aqueous phase III (3% (w/w of spirit vinegar and 0.5% (w/w) of salt) was added, then the remaining oil was poured into the mixture.

Five different mayonnaises were prepared using the above technique.

1) a control mayonnaise, where no extract was added;

2) a mayonnaise containing 0.4% by weight BW26 extract;

3) a mayonnaise containing 0.2% by weight BW26 extract;

4) a mayonnaise containing 0.4% by weight BW26 and a rosemary extract; and

5) a mayonnaise containing 1% rosemary extract.

Each of the mayonnaises was subjected to accelerated aging in an oven at 50° C. over five weeks. Every week, each mayonnaise was tested for the formation of volatile compounds using HS-SPME coupled to GC/MS. This process consisted of placing the to sample in a vial, which was then sealed with a septum-type cap or with a Miniert valve. The SPME needle then pierced the septum and a fibre was extended through the needle into the sample. Partitioning between the sample matrix and stationary phase was then allowed to take place. Analytes in the sample are absorbed onto the fibre as equilibrium is reached. The fibre is then transferred to the injection port of a gas chromatograph where the analytes are thermally desorbed.

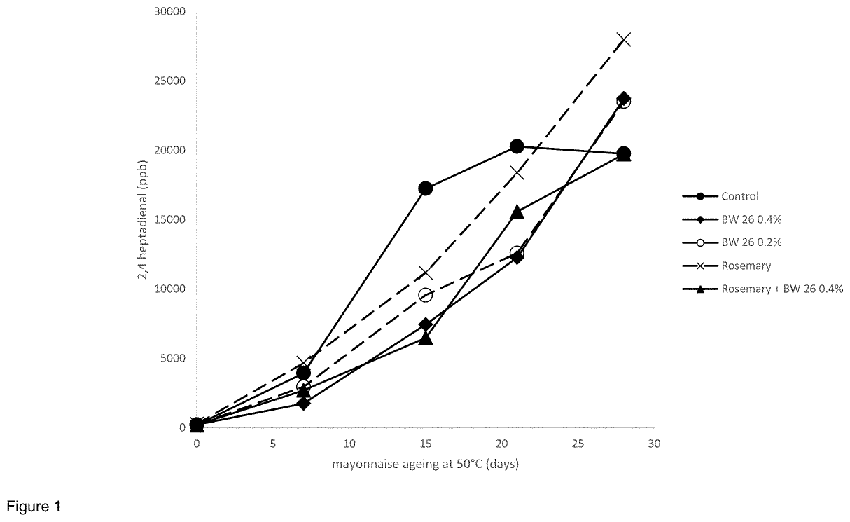

The oxidative stability of the mayonnaise was evaluated by measurements of 2,4-heptadienal (ppb) and the results are shown in FIG. 1.

As can be seen from FIG. 1, the formation of 2,4-heptadienal was reduced for 25 days when the mayonnaise contained BW26 extract.

Colour

The extract had a DL (1%)=−65

With a DL of −65, BW26 coloured the mayonnaise with a light grey colour.

### Example 2

### Buckwheat Mayo 1 (BW Mayo 1)

Preparation of Extract

Buckwheat hull was ground to particles of approximately 2 mm. The ground sample was then extracted 2 times for 2 hours at reflux with water at pH3 (acidified with nitric acid 20%) which represented a 10M ratio of the mass plant. The mixture was then filtrated. The liquid extract was evaporated with a rotary evaporator (Heidolph) with 25% of maltodextrin until dryness. The dry extract was then ground yielding ground BW mayo 1 extract.

The ground extract was subjected to In-vitro screening of chelating activity and In-vitro free radical scavenging activity testing as described above. The results of these tests are shown in Table 2.

TABLE 2
results of ferrozine and DPPH tests for BW mayo 1

| Chelating activity | | | Free radical |
|---|---|---|---|
| | | % Fe (II) | scavenging activity |
| Slope | C(mg/mL) | chelated | Area 1 μL |
| 13 | 1 | 13.1 | 20 099 |
| | 2.5 | 34.4 | |
| | 5 | 62.3 | |
| | 10 | 83.2 | |
| | 15 | 82.4 | |
| | 20 | 83.1 | |

As can be seen from Table 2, BW mayo 1 responded to the ferrozine test with a positive chelating activity with a slope at 13 and a % Fe (II) chelated at 1% equal to 83.2%. BW mayo 1 had also a positive free radical scavenging activity with an area of 20 099.

Preparation of the Mayonnaise

The aqueous phase I (20.69% (w/w) of water, 5% (w/w) of pasteurise egg yolk and 0.1% (w/w) of potassium sorbate), was mixed with an ultra Turax. Next, if included, the BW mayo1 extract was mixed with the phase I. Then the aqueous phase II (0.2% (w/w) of Lygomme KCT 58, 0.5% (w/w) of Cemtex 12688 and 2.1% (w/w) of colza oil) was added to the mixture. Once the mixture was homogenised, 67.9% (w/w) of colza oil was added slowly against the Turax's stem with a vigorous agitation. At ⅔ of the oil addition, the aqueous phase III (3% (w/w of spirit vinegar and 0.5% (w/w) of salt) was added, then the remaining oil was poured.

Four different mayonnaises were prepared using the above technique.

1) a control mayonnaise, where no extract was added;

2) a mayonnaise containing 0.4% by weight BW mayo 1 extract;

3) a mayonnaise containing 0.2% by weight BW mayo 1 extract; and

4) a mayonnaise containing 1% by weight BW mayo 1 extract.

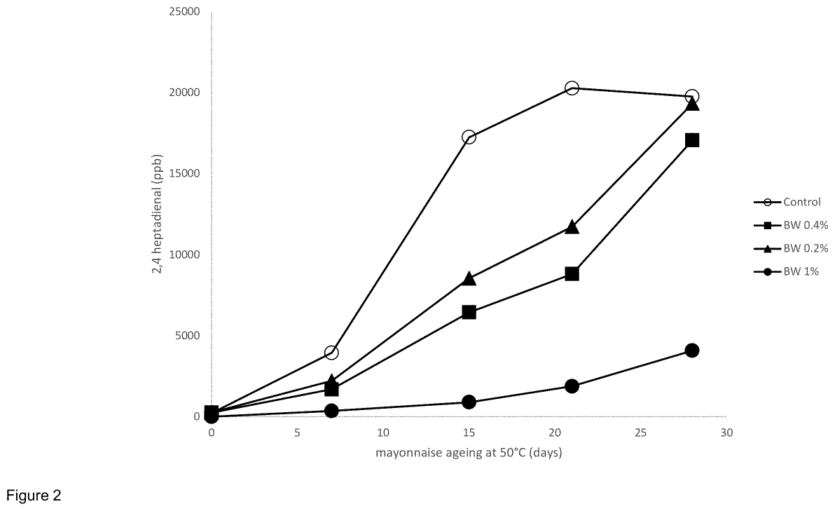

Each of the mayonnaises was subjected to accelerated aging in an oven at 50° C. over five weeks as described in Example 1. The results are shown in FIG. 2.

As can be seen in FIG. 2, BW mayo1 reduced mayonnaise oxidation throughout the duration of the accelerated ageing. When included in the mayonnaise at 1% by weight, the rate of 2,4 heptadienal after 28 days of accelerated ageing at 50° C. didn't exceed 5000 ppb.

Colour

The extract had a DL (1%)=−74.76

With a DL of −74.76, BW mayo 1 coloured the mayonnaise with a grey-brown colour.

### Example 3

### Buckwheat 25D (BW25D)

Preparation of Extract

Buckwheat hull were ground to particles of approximately 2 mm. The ground sample was then extracted two times for 2 hours at 65° C. with a mixture of 70% water at pH3 (acidified with nitric acid 20%)/30% Ethanol 96° which represented a 10M ratio of the mass plant. The mixture was then filtered. The mixture was then decolourised with coal. The decolourised liquid extract was evaporated with a rotary evaporator (Heidolph) with 25% of maltodextrin until dryness. The dry extract was then ground yielding ground buckwheat 25D extract (BW 25D).

The ground extract was subjected to In-vitro screening of chelating activity and In-vitro free radical scavenging activity testing as described above. The results of these tests are shown in Table 3.

TABLE 3
results of ferrozine and DPPH tests for BW25D

| Chelating activity | | | Free radical |
|---|---|---|---|
| | | % Fe (II) | scavenging activity |
| Slope | C (mg/mL) | chelated | Area 1 μL |
| 17 | 1 | 11.3 | 9 336 |
| | 2.5 | 22.4 | |
| | 5 | 51.0 | |
| | 10 | 85.5 | |
| | 15 | 92.7 | |
| | 20 | 105.5 | |

As can be seen in Table 3, BW25D responded to the ferrozine test with a positive chelating activity with a slope at 17 and a % Fe (II) chelated at 1% equal to 85.5%. BW25D had also a positive free radical scavenging activity with an area of 9 336.

Preparation of the Mayonnaise

The aqueous phase I (20.69% (w/w) of water, 5% (w/w) of pasteurise egg yolk and 0.1% (w/w) of potassium sorbate), was mixed with an ultra Turax. Next, if included, the BW25D extract was mixed with the phase I. Then the aqueous phase II (0.2% (w/w) of Lygomme KCT 58, 0.5% (w/w) of Cemtex 12688 and 2.1% (w/w) of colza oil) was added to the mixture. Once the mixture was homogenised, 67.9% (w/w) of colza oil was added slowly against the Turax's stem with a vigorous agitation. At ⅔ of the oil addition, the aqueous phase III (3% (w/w of spirit vinegar and 0.5% (w/w) of salt) was added, then the remaining oil was poured.

Five different mayonnaises were prepared using the above technique.

1) a control mayonnaise, where no extract was added;

2) a mayonnaise containing 0.4% by weight BW25D extract;

3) a mayonnaise containing 0.2% by weight BW25D extract;

4) a mayonnaise containing 0.4% by weight BW25D and 0.5% by weight rosemary extract; and

5) a mayonnaise containing 0.5% by weight rosemary extract.

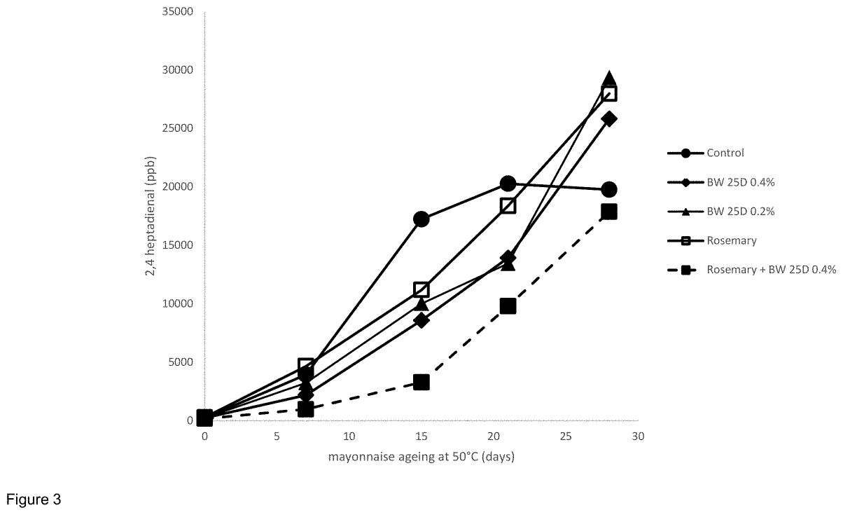

Each of the mayonnaises was subjected to accelerated aging in an oven at 50° C. over five weeks as described in Example 1. The results are shown in FIG. 3.

As can be seen from FIG. 3, both the combination of 1% rosemary extract that comprised 0.5% carnosic acid and carnosol (OSR 0.5)+BW25D 0.4% and a dosage of 0.4% and 0.2% of BW25D prevented the mayonnaise from oxidation. Interestingly, on its own, the rosemary did not significantly reduce oxidation.

Colour

The extract had a DL (1%)=−35

With a DL of −35, BW25D coloured the mayonnaise with a light grey but coloured the mayonnaise less than BW26.

### Example 4

### Quinoa C

Preparation of Extract

Quinoa C hull was ground to particles of approximately 2 mm. The ground sample was then extracted two times with a mixture of 70% water at pH3 (acidified with nitric acid 20%)/30% Ethanol 96° which represented a 10M ratio of the mass plant. The mixture was then filtered. The liquid extract was evaporated with a rotary evaporator (Heidolph) with 25% of maltodextrin until dryness. The dry extract was then ground yielding ground quinoa C extract.

The ground extract was subjected to In-vitro screening of chelating activity and In-vitro free radical scavenging activity testing as described above. The results of these tests are shown in Table 4.

TABLE 4
results of ferrozine and DPPH tests for Quinoa C

| Chelating activity | | | Free radical |
|---|---|---|---|
| | | % Fe (II) | scavenging activity |
| Slope | C (mg/mL) | chelated | Area 1 μL |
| 10 | 1 | 11.8 | 7 320 |
| | 2.5 | 24.6 | |
| | 5 | 51.8 | |
| | 10 | 77.7 | |
| | 15 | 91.4 | |
| | 20 | 95.3 | |

As can be seen from Table 4, Quinoa C responded to the ferrozine test with a positive chelating activity with a slope at 10 and a % Fe (II) chelated at 1% equal to 77.7%. Quinoa C had also a positive free radical scavenging activity with an area of 7 320.

Preparation of the Mayonnaise

The aqueous phase I (20.69% (w/w) of water, 5% (w/w) of pasteurise egg yolk and 0.1% (w/w) of potassium sorbate), was mixed with an ultra Turax. Next, if included, the quinoa C extract was mixed with the phase I. Then the aqueous phase II (0.2% (w/w) of Lygomme KCT 58, 0.5% (w/w) of Cemtex 12688 and 2.1% (w/w) of colza oil) was added to the mixture. Once the mixture was homogenised, 67.9% (w/w) of colza oil was added slowly against the Turax's stem with a vigorous agitation. At ⅔ of the oil addition, the aqueous phase III (3% (w/w of spirit vinegar and 0.5% (w/w) of salt) was added, then the remaining oil was poured.

Five different mayonnaises were prepared using the above technique.

1) a control mayonnaise, where no extract was added;

2) a mayonnaise containing 0.4% by weight Quinoa C extract;

3) a mayonnaise containing 0.2% by weight Quinoa C extract;

4) a mayonnaise containing 0.4% by weight Quinoa C and 0.5% by weight rosemary extract; and

5) a mayonnaise containing 0.5% by weight rosemary extract.

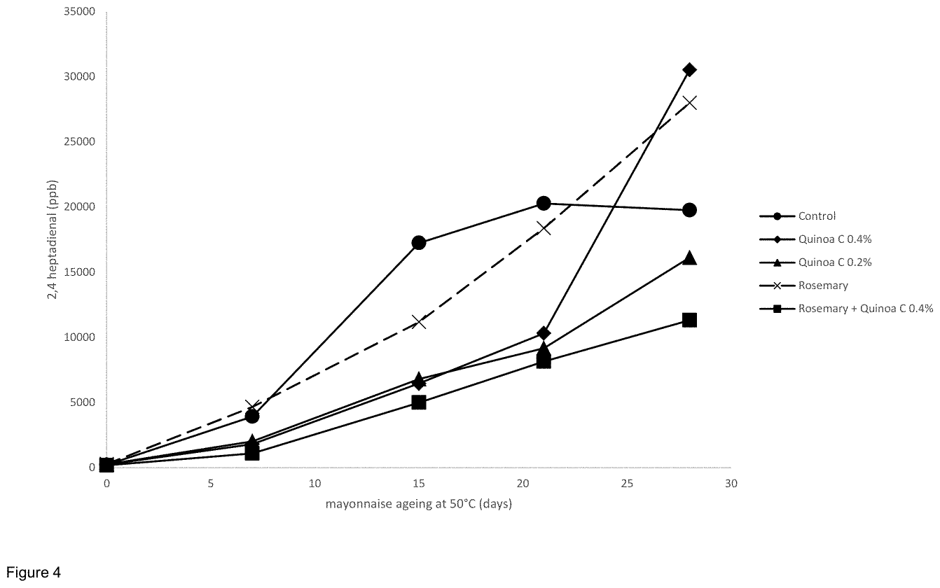

Each of the mayonnaises was subjected to accelerated aging in an oven at 50° C. over five weeks as described in Example 1. The results are shown in FIG. 4.

Colour

The extract had a DL (1%)=−11

The extract didn't affect the colour of the mayonnaise.

### Example 5

### Quinoa A

Preparation of Extract

Quinoa A hull was ground to particles of approximately 2 mm. The ground sample was then extracted two times for 2 hours at reflux with a mixture of 70% water at pH3 (acidified with nitric acid 20%)/30% Ethanol 96° which represented a 10M ratio of the mass plant. The mixture was then filtered. The liquid extract was evaporated with a rotary evaporator (Heidolph) with 25% of maltodextrin until dryness. The dry extract was then ground yielding ground Quinoa A extract.

The ground extract was subjected to In-vitro screening of chelating activity and In-vitro free radical scavenging activity testing as described above. The results of these tests are shown in Table 5.

TABLE 5
results of ferrozine and DPPH tests for Quinoa A

| Chelating activity | | | Free radical |
|---|---|---|---|
| | | % Fe (II) | scavenging activity |
| Slope | C (mg/mL) | chelated | Area 1 μL |
| 17 | 1 | 14.0 | 7366 |
| | 2.5 | 39.1 | |
| | 5 | 90.4 | |
| | 10 | 99.8 | |
| | 15 | 99.5 | |
| | 20 | 99.5 | |

As can be seen from Table 5, Quinoa A hull extract responded to the ferrozine test with a positive chelating activity with a slope at 17 and a % Fe (II) chelated at 1% equal to 100%. Quinoa A extracted with 70% water pH3/30% Ethanol 96° was a free radical scavenging activity with an area of 7 366.

The Quinoa A hull were also extracted with the same process but with water only at pH3. This extract had a slope at 16 and a % Fe(II) chelated at 1% equal to 98%. Thus, it had the same chelating activity as Quinoa A hull water/EtOH 25°.

Preparation of the Mayonnaise

The aqueous phase I (20.69% (w/w) of water, 5% (w/w) of pasteurise egg yolk and 0.1% (w/w) of potassium sorbate), was mixed with an ultra Turax. Next, if included, the quinoa A extract was mixed with the phase I. Then the aqueous phase II (0.2% (w/w) of Lygomme KCT 58, 0.5% (w/w) of Cemtex 12688 and 2.1% (w/w) of colza oil) was added to the mixture. Once the mixture was homogenised, 67.9% (w/w) of colza oil was added slowly against the Turax's stem with a vigorous agitation. At ⅔ of the oil addition, the aqueous phase III (3% (w/w of spirit vinegar and 0.5% (w/w) of salt) was added, then the remaining oil was poured.

Seven different mayonnaises were prepared using the above technique.

1) a control mayonnaise, where no extract was added;

2) a mayonnaise containing 0.5% by weight rosemary extract

3) a mayonnaise containing 0.4% by weight Quinoa A extract;

4) a mayonnaise containing 0.2% by weight Quinoa A extract;

5) a mayonnaise containing 0.4% by weight Quinoa A and 0.5% by weight rosemary extract;

6) a mayonnaise containing 1% by weight Quinoa A extract; and

7) a mayonnaise containing 1% by weight Quinoa A extract (waterpH3).

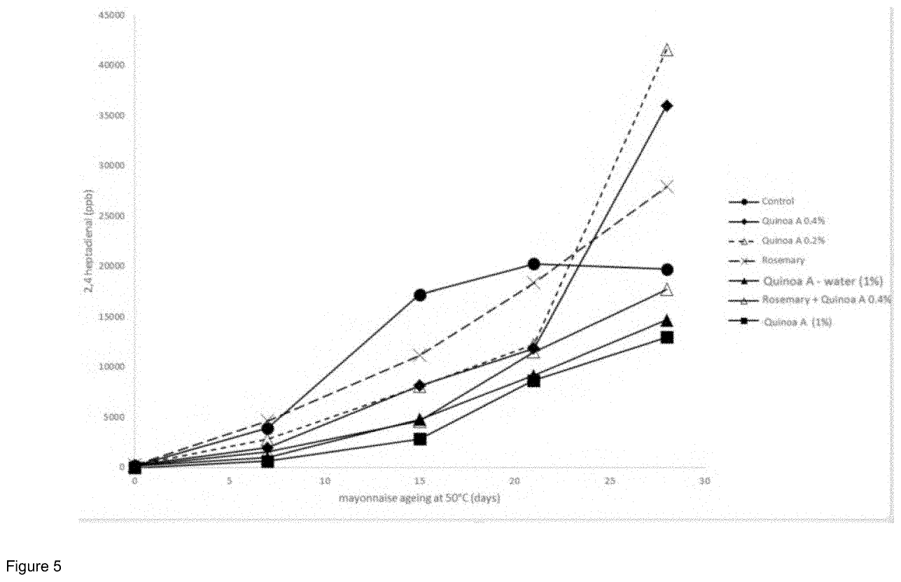

Each of the mayonnaises were then subjected to accelerated aging in an oven at 50° C. over five weeks as described in Example 1. The results are shown in FIG. 5.

Colour

The extract had a DL (1%)=−22

The extract didn't affect the colour of the mayonnaise.

### Example 6

### Quinoa B

Preparation of Extract

Quinoa B hull was ground to particles of approximately 2 mm. The ground sample was then extracted two times for 2 hours at reflux with water at pH3 (acidified with nitric acid 20%) which represented a 10M ratio of the mass plant. The mixture was then filtered. The liquid extract was evaporated with a rotary evaporator (Heidolph) with 25% of maltodextrin until dryness. The dry extract was then ground yielding 31.32% of ground Quinoa B extract.

The ground extract was subjected to In-vitro screening of chelating activity and In-vitro free radical scavenging activity testing as described above. The results of these tests are shown in Table 6.

TABLE 6
results of ferrozine and DPPH tests for Quinoa B

| Chelating activity | | | Free radical |
|---|---|---|---|
| | | % Fe (II) | scavenging activity |
| Slope | C (mg/mL) | chelated | Area 1 μL |
| 10 | 1 | 7.7 | NA |
| | 2.5 | 22.7 | |
| | 5 | 51.5 | |
| | 10 | 95.6 | |
| | 15 | 105.6 | |
| | 20 | 110.3 | |

As can be seen from Table 6, Quinoa B hull extract responded to the ferrozine test with a positive chelating activity with a slope at 10 and a % Fe (II) chelated at 1% equal to 95.6%.

Preparation of the Mayonnaise

The aqueous phase I (19.7% (w/w) of water, 5% (w/w) of pasteurise egg yolk and 0.1% (w/w) of potassium sorbate), was mixed with a stephan. Next, if included, the quinoa B extract and/or rosemary extract, was mixed with the phase I. Then the aqueous phase II (0.2% (w/w) of Lygomme KCT 58, 0.5% (w/w) of Cemtex 12688 and 2.1% (w/w) of colza oil) was added to the mixture. Once the mixture was homogenised, 67.9% (w/w) of colza oil was added. Finally, the aqueous phase III (3% (w/w of spirit vinegar and 0.5% (w/w) of salt) was added.

Six different mayonnaises were prepared using the above technique.

1) a control mayonnaise, where no extract was added;

2) a mayonnaise containing 1% by weight rosemary extract (RE WS (water soluble));

3) a mayonnaise containing 1% by weight rosemary extract (RE OS (oil soluble));

4) a mayonnaise containing 0.4% by weight Quinoa B extract;

5) a mayonnaise containing 0.4% by weight Quinoa B and 1% by weight rosemary extract (RE OS); and

6) a mayonnaise containing 0.4% by weight Quinoa B and 1% by weight rosemary extract (RE WS).

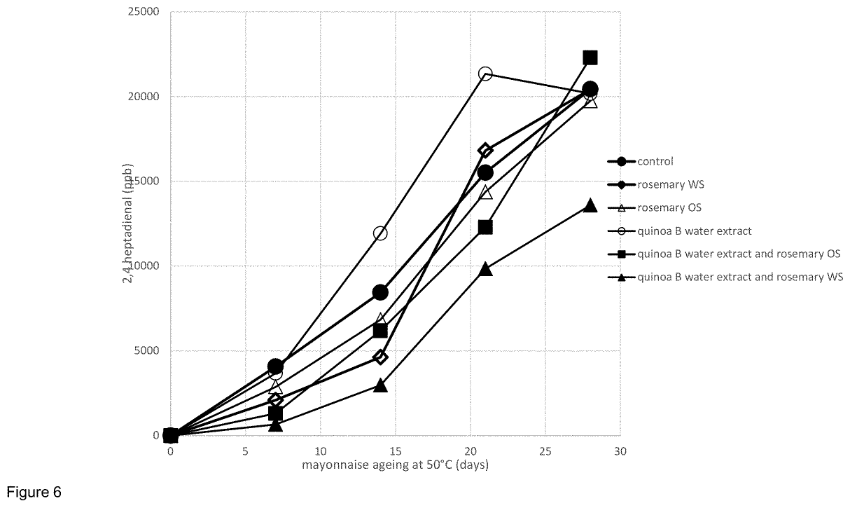

Each of the mayonnaises was subjected to accelerated aging in an oven at 50° C. over five weeks as described in Example 1. The results are shown in FIG. 6.

As can be seen from FIG. 6, the combination of RE WS and Quinoa B hull protected the mayonnaise from oxidation during 28 days.

Colour

The extract didn't affect the colour of the mayonnaise.

### Example 7

### Quinoa Red Hull

Preparation of Extract

Quinoa Red Hull was ground to particles of approximately 2 mm. The ground sample was then extracted two times for 2 hours at reflux with water at pH3 (acidified with nitric acid 20%) which represented a 10M ratio of the mass plant. The mixture was then filtered with depth filter sheet Fibratix AF6+AF31H at 25° C. The liquid extract was evaporated with a rotary evaporator (Heidolph) with 25% of maltodextrin until dryness. The dry extract was then ground yielding 44.88% of ground Quinoa Red Hull extract.

The ground extract was subjected to In-vitro screening of chelating activity and In-vitro free radical scavenging activity testing as described above. The results of these tests are shown in Table 7.

TABLE 7
results of ferrozine and DPPH tests for Quinoa Red Hull

| Chelating activity | | | Free radical |
|---|---|---|---|
| | | % Fe (II) | scavenging activity |
| Slope | C (mg/mL) | chelated | Area 1 μL |
| 6 | 1 | 10.3 | NA |
| | 2.5 | 23.1 | |
| | 5 | 27.7 | |
| | 10 | 86.6 | |
| | 15 | 133.7 | |
| | 20 | 101.0 | |

As can be seen from Table 7, Quinoa red hull extract responded to the ferrozine test with a positive chelating activity with a slope at 6 and a % Fe (II) chelated at 1% equal to 86.6%.

Preparation of the Mayonnaise

The aqueous phase I (19.7% (w/w) of water, 5% (w/w) of pasteurise egg yolk and 0.1% (w/w) of potassium sorbate), was mixed with a stephan. Next, if included, the quinoa red hull extract and/or the rosemary extract was mixed with the phase I. Then the aqueous phase II (0.2% (w/w) of Lygomme KCT 58, 0.5% (w/w) of Cemtex 12688 and 2.1% (w/w) of colza oil) was added to the mixture. Once the mixture was homogenised, 67.9% (w/w) of colza oil was added. Finally, the aqueous phase III (3% (w/w of spirit vinegar and 0.5% (w/w) of salt) was added.

Six different mayonnaises were prepared using the above technique.

1) a control mayonnaise, where no extract was added;

2) a mayonnaise containing 1% by weight rosemary extract (RE WS);

3) a mayonnaise containing 1% by weight rosemary extract (RE OS);

4) a mayonnaise containing 0.4% by weight Quinoa Red hull extract;

5) a mayonnaise containing 0.4% by weight Quinoa Red hull and 1% by weight rosemary extract (RE OS); and

6) a mayonnaise containing 0.4% by weight Quinoa Red hull and 1% by weight rosemary extract (RE WS).

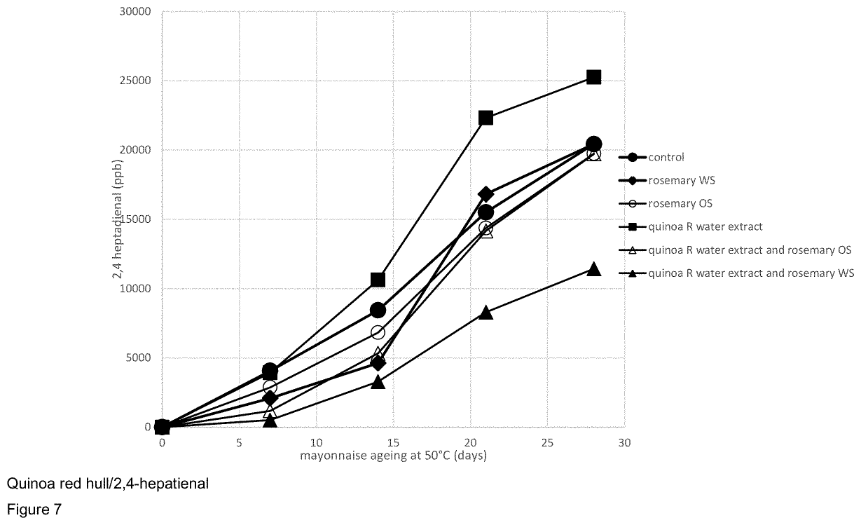

Each of the mayonnaises was subjected to accelerated aging in an oven at 50° C. over five weeks as described in Example 1. The results are shown in FIG. 7.

Colour

The extract didn't affect the colour of the mayonnaise.

### Example 8

### Quinoa C Whole (Ethanol Extract)

Preparation of Extract

Quinoa C whole seeds was ground to particles of approximately 2 mm. The ground sample was then extracted by Soxhlet apparatus with water (at pH 3)/EtOH 30/70 which represented a 10M ratio of the mass plant. The mixture was then filtered. The liquid extract was evaporated with a rotary evaporator (Heidolph) with 25% of maltodextrin until dryness. The dry extract was then ground yielding ground Quinoa C whole.

The ground extract was subjected to in-vitro screening of chelating activity and In-vitro free radical scavenging activity testing as described above. The results of these tests are shown in Table 8.

TABLE 8
results of ferrozine and DPPH tests for Quinoa C whole

| | |
|---|---|
| Chelating activity | Free radical |

| | % Fe (II) | scavenging activity |
|---|---|---|
| Slope | chelated at 1% | Area 1 μL |
| 10.34 | 81.11 | NA |

As can be seen from Table 8, Quinoa C whole extract responded to the ferrozine test with a positive chelating activity with a slope at 10.34 and a % Fe (II) chelated at 1% equal to 81.11%.

Preparation of the Mayonnaise

The aqueous phase I (19.7% (w/w) of water, 5% (w/w) of pasteurise egg yolk and 0.1% (w/w) of potassium sorbate), was mixed with a stephan. Next, if included, 1% (w/w) of the quinoa C extract was mixed with the phase I. Then the aqueous phase II (0.2% (w/w) of Lygomme KCT 58, 0.5% (w/w) of Cemtex 12688 and 2.1% (w/w) of colza oil) was added to the mixture. Once the mixture was homogenised, 67.9% (w/w) of colza oil was added. Finally, the aqueous phase III (3% (w/w of spirit vinegar and 0.5% (w/w) of salt) was added.

Two different mayonnaises were prepared using the above technique.

1) a control mayonnaise, where no extract was added;

2) a mayonnaise containing 1% by weight Quinoa C whole extract (EtOH)

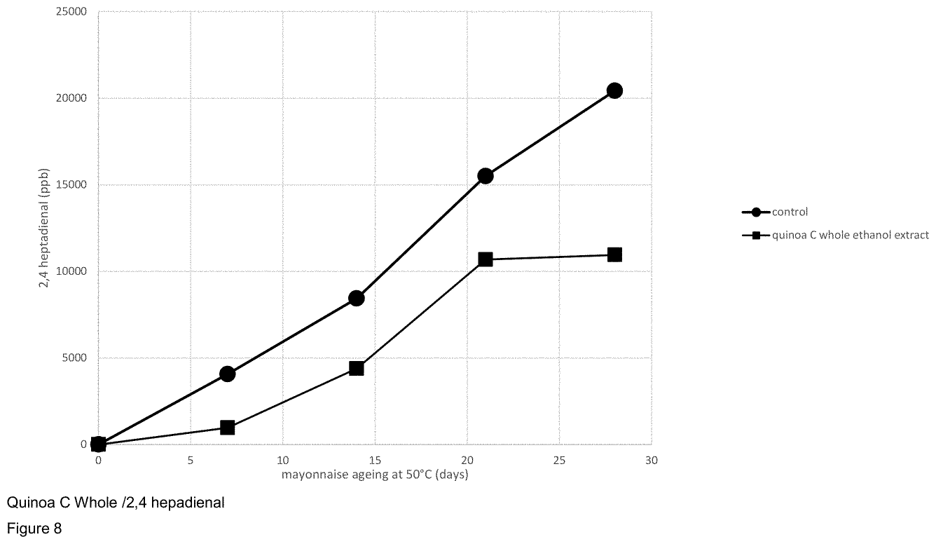

Each of the mayonnaises was subjected to accelerated aging in an oven at 50° C. over five weeks as described in Example 1. The results are shown in FIG. 8.

As can be seen from FIG. 8, the Quinoa C whole extract protected the mayonnaise from oxidation throughout the duration of the accelerated ageing at 50° C. (28 days).

Colour

The extract didn't affect the colour of the mayonnaise.

### Example 9

### Quinoa A (Water Extract)

Preparation of Extract

Quinoa A hull was ground to particles of approximately 2 mm. The ground sample was then extracted two times for 2 hours at reflux with water at pH3 (acidified with nitric acid 20%) which represented a 10M ratio of the mass plant. The mixture was then filtered. The liquid extract was evaporated with a rotary evaporator (Heidolph) with 25% of maltodextrin until dryness. The dry extract was then ground yielding ground Quinoa A extract.

The ground extract was subjected to In-vitro screening of chelating activity and In-vitro free radical scavenging activity testing as described above. The results of these tests are shown in Table 9.

TABLE 9
results of ferrozine and DPPH tests for quinoa A (water extract)

| Chelatingactivity | | | Free radical |
|---|---|---|---|
| | | % Fe (II) | scavengingactivity |
| Slope | C (mg/mL) | chelated | Area 1 μL |
| 19 | 1 | 5.9 | 2478 |
| | 2.5 | 48.2 | |
| | 5 | 97.0 | |
| | 10 | 104.1 | |
| | 15 | 102.7 | |
| | 20 | 94.8 | |

As can be seen from Table 9, the quinoa A hull extract responded to the ferrozine test with a positive chelating activity with a slope at 19 and a % Fe (II) chelated at 1% equal to 104.1%. Quinoa A hull extract was a free radical scavenging activity with an area of 2 478.

Preparation of the Mayonnaise

The aqueous phase I (20.69% (w/w) of water, 5% (w/w) of pasteurise egg yolk and 0.1% (w/w) of potassium sorbate), was mixed with an ultra Turax. Next, if included, the quinoa A extract was mixed with the phase I. Then the aqueous phase II (0.2% (w/w) of Lygomme KCT 58, 0.5% (w/w) of Cemtex 12688 and 2.1% (w/w) of colza oil) was added to the mixture. Once the mixture was homogenised, 67.9% (w/w) of colza oil was added slowly against the Turax's stem with a vigorous agitation. At ⅔ of the oil addition, the aqueous phase III (3% (w/w of spirit vinegar and 0.5% (w/w) of salt) was added, then the remaining oil was poured.

Three different mayonnaises were prepared using the above technique.

1) a control mayonnaise, where no extract was added;

2) a mayonnaise containing 1% by weight quinoa A extract; and

3) a mayonnaise containing 0.6% by weight quinoa A extract

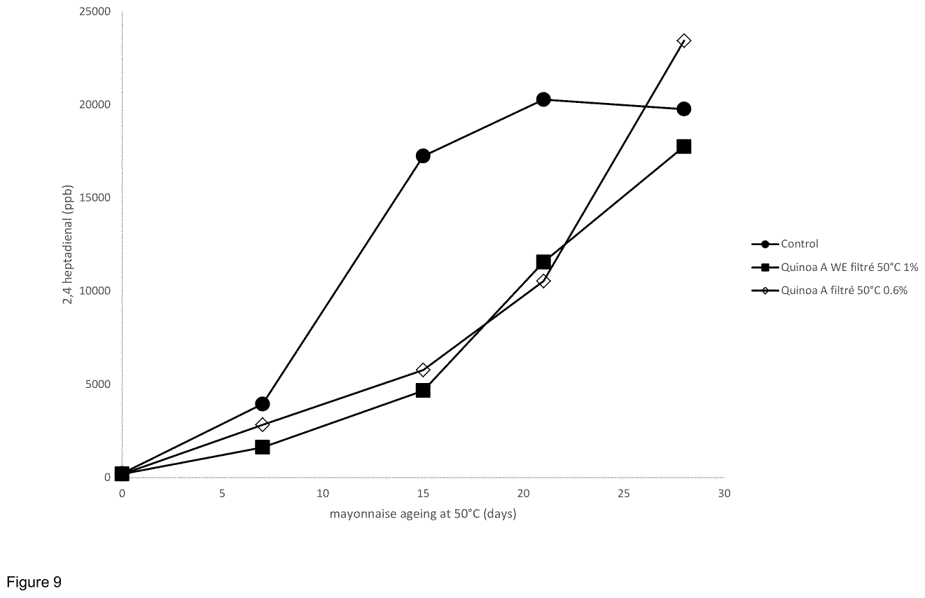

Each of the mayonnaises were then subjected to accelerated aging in an oven at 50° C. over five weeks as described in Example 1. The results are shown in FIG. 9.

As can be seen from FIG. 9, quinoa A hull extract protected the mayonnaise from oxidation throughout the duration of the accelerated ageing at 50° C. (28 days).

Colour

The extract had a DL (1%)=−11

The extract didn't affect the colour of the mayonnaise.

### Example 10

### Chia Juice

Preparation of Extract

Chia seeds were germinated for 11 days. Each day the seeds were sprayed with water. On the 11^{th} day, the germinated seeds were rinsed with water and then centrifuged with a centrifuge juice (Hurom). The liquid mixture was centrifuged a further two times at 4000 rpm for 20 min. The liquid was then collected and evaporated with a rotary evaporator (Heidolph) until dryness. The dry extract was finally ground.

The ground extract was subjected to In-vitro screening of chelating activity and In-vitro free radical scavenging activity testing as described above. The results of these tests are shown in Table 10.

TABLE 10
results of ferrozine and DPPH tests for chia juice extract

| Chelating activity | | | Free radical |
|---|---|---|---|
| | | % Fe (II) | scavenging activity |
| Slope | C (mg/mL) | chelated | Area 1 μL |
| 11 | 1.25 | 9.9 | 709 |
| | 2.5 | 24.4 | |
| | 5 | 54.0 | |
| | 10 | 86.9 | |
| | 15 | 90.3 | |

As can be seen from Table 10, chia juice responded to the ferrozine test with a positive chelating activity with a slope at 11 and a % Fe (II) chelated at 1% equal to 86.9%. Chia juice had a free radical scavenging activity with an area of 709.

Preparation of the Mayonnaise

The aqueous phase I (20.69% (w/w) of water, 5% (w/w) of pasteurise egg yolk and 0.1% (w/w) of potassium sorbate), was mixed with an ultra Turax. Next, if included, the chia extract was mixed with the phase I. Then the aqueous phase II (0.2% (w/w) of Lygomme KCT 58, 0.5% (w/w) of Cemtex 12688 and 2.1% (w/w) of colza oil) was added to the mixture. Once the mixture was homogenised, 67.9% (w/w) of colza oil was added slowly against the Turax's stem with a vigorous agitation. At ⅔ of the oil addition, the aqueous phase III (3% (w/w of spirit vinegar and 0.5% (w/w) of salt) was added, then the remaining oil was poured.

Three different mayonnaises were prepared.

1) a control mayonnaise, where no extract was added;

2) a mayonnaise containing 0.5% by weight rosemary OS extract; and

3) a mayonnaise containing 0.5% by weight rosemary OS extract and 1% by weight chia juice extract.

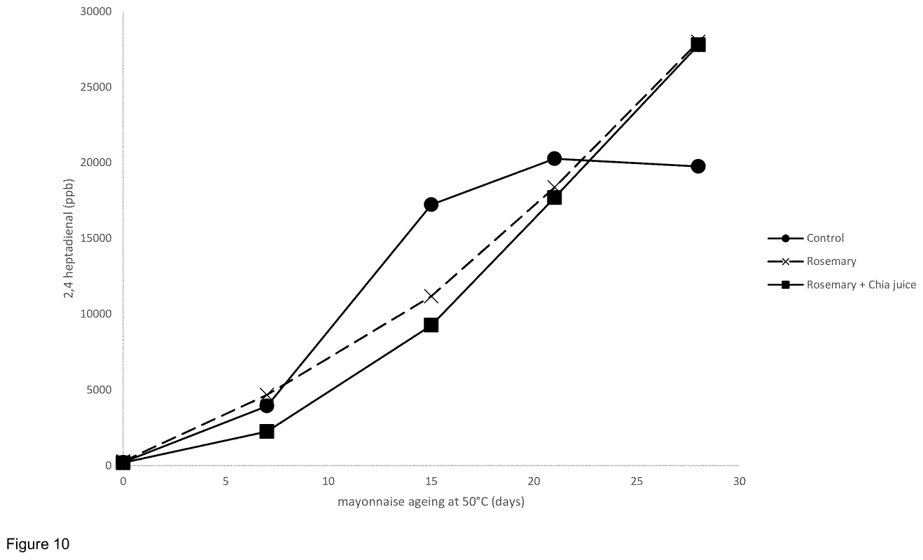

Each of the mayonnaises were then subjected to accelerated aging in an oven at 50° C. over five weeks as described in Example 1. The results are shown in FIG. 10.

Colour

Chia juice coloured the mayonnaise with a darker colour turning slightly blue/green.

### Example 11

### Alfalfa Germinated Seeds

Alfalfa seeds were germinated for 8 days. Each day the seeds were sprayed with water. On the 11^{th} day, the germinated seeds were rinsed with water and then extracted with a Soxhlet apparatus with 70% water/30% Ethanol 96° at reflux over 8 hours. The solvent for the extraction represented a 10M ratio of the mass plant. Once cooled, the mixture was filtered. The liquid extract was evaporated with rotary evaporator (Heidolph) until dryness with 25% of maltodextrin. The dry extract was finally ground.

The ground extract was then subjected to In-vitro screening of chelating activity and In-vitro free radical scavenging activity testing as described above. The results of these tests are shown in Table 11.

TABLE 11
results of ferrozine and DPPH tests
for alfalfa germinated seed extract

| Chelatingactivity | | | Free radical |
|---|---|---|---|
| | | % Fe (II) | scavengingactivity |
| Slope | C (mg/mL) | chelated | Area 1 μL |
| 13.1 | 1.25 | 14.3 | 1795 |
| | 2.5 | 31.3 | |
| | 5 | 66.6 | |
| | 10 | 80.3 | |
| | 15 | 86.4 | |
| | 20 | 91.2 | |

As can be seen from Table 11, alfalfa germinated seeds extracts responded to the ferrozine test with a positive chelating activity with a slope at 13.1 and a % Fe (II) chelated at 1% equal to 80.3%. However, alfalfa germinated seeds had only a free radical scavenging activity with an area of 1795.

The alfalfa germinated seeds were also extracted using the same process but with water pH3. This extract had a slope at 5.8 and a % Fe(II) chelated at 1% equal to 48.1%.

Preparation of the Mayonnaise

The aqueous phase I (20.69% (w/w) of water, 5% (w/w) of pasteurise egg yolk and 0.1% (w/w) of potassium sorbate), was mixed with an ultra Turax. Next, if included, the alfalfa extract was mixed with the phase I. Then the aqueous phase II (0.2% (w/w) of Lygomme KCT 58, 0.5% (w/w) of Cemtex 12688 and 2.1% (w/w) of colza oil) was added to the mixture. Once the mixture was homogenised, 67.9% (w/w) of colza oil was added slowly against the Turax's stem with a vigorous agitation. At ⅔ of the oil addition, the aqueous phase III (3% (w/w of spirit vinegar and 0.5% (w/w) of salt) was added, then the remaining oil was poured.

Three different mayonnaises were prepared.

1) a control mayonnaise, where no extract was added;

2) a mayonnaise containing 0.5% by weight rosemary OS extract; and

3) a mayonnaise containing 0.5% by weight rosemary OS extract and 1% by weight alfalfa germinated seed extract.

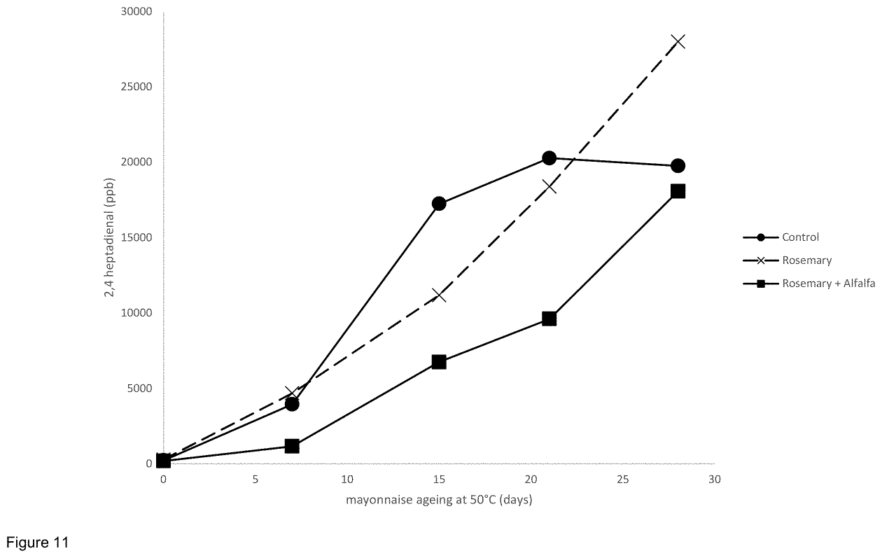

Each of the mayonnaises were then subjected to accelerated aging in an oven at 50° C. over five weeks as described in Example 1. The results are shown in FIG. 11.

Colour

Alfalfa germinated seeds extracts coloured the mayonnaise with a darker colour turning slightly blue/green.

### Example 12

### Hemp Seed Extract

Unhusked hemp seeds were extracted with a Soxhlet apparatus with water at pH3 (acidified with nitric acid 20%) at reflux during 8 h. The solvent for the extraction represented a 10M ratio of the mass plant. Once cooled, the mixture was filtered. The liquid extract was evaporated with a rotary evaporator (Heidolph) until dryness with 25% of maltodextrin. The dry extract was finally ground.

The ground extract was subjected to In-vitro screening of chelating activity and In-vitro free radical scavenging activity testing as described above. The results of these tests are shown in Table 12.

TABLE 12
results of ferrozine and DPPH tests for hemp seed extract

| Chelating activity | | | Free radical |
|---|---|---|---|
| | | % Fe (II) | scavenging activity |
| Slope | C (mg/mL) | chelated | Area 1 μL |
| 8.2 | 1.25 | 14.5 | 1762 |
| | 2.5 | 23.0 | |
| | 5 | 38.3 | |
| | 10 | 68.3 | |
| | 15 | 75.9 | |
| | 20 | 80.7 | |

As can be seen from Table 12, hemp seeds extracts responded to the ferrozine test with a positive chelating activity with a slope at 8.2 and a % Fe (II) chelated at 1% equal to 68.3%.

The hemp seeds were also extracted with the same process but with water/EtOH 70/30. This extract had a slope at 4.9 and a % Fe(II) chelated at 1% equal to 38.9%.

Preparation of the Mayonnaise

The aqueous phase I (20.69% (w/w) of water, 5% (w/w) of pasteurise egg yolk and 0.1% (w/w) of potassium sorbate), was mixed with an ultra Turax. Next, if included, the hemp seed extract was mixed with the phase I. Then the aqueous phase II (0.2% (w/w) of Lygomme KCT 58, 0.5% (w/w) of Cemtex 12688 and 2.1% (w/w) of colza oil) was added to the mixture. Once the mixture was homogenised, 67.9% (w/w) of colza oil was added slowly against the Turax's stem with a vigorous agitation. At ⅔ of the oil addition, the aqueous phase III (3% (w/w of spirit vinegar and 0.5% (w/w) of salt) was added, then the remaining oil was poured.

Three different mayonnaises were prepared.

1) a control mayonnaise, where no extract was added;

2) a mayonnaise containing 0.5% by weight rosemary OS extract; and

3) a mayonnaise containing 0.5% by weight rosemary OS extract and 1% by weight hemp seed extract.

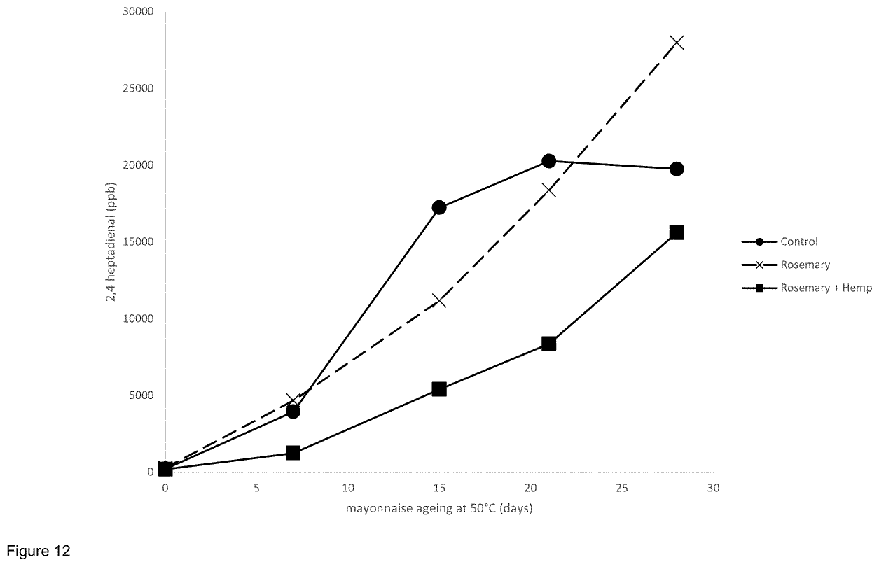

Each of the mayonnaises were then subjected to accelerated aging in an oven at 50° C. over five weeks as described in Example 1. The results are shown in FIG. 12.

Colour

The extract didn't affect the colour of the mayonnaise.

### Example 13

### Extraction of Peas

Peas were extracted using water at pH3 (with nitric acid or phosphoric or citric acid), 70% ethanol.

The raw pea material (crushed) and solvent were placed in a round bottom flask (or a round reactor vessel for larger quantities), in a ratio of 10 mL of solvent for each gram of raw material. The mix was then mechanically shaken, extracted and then centrifuged. The raw material was recovered for a second extraction, under the same conditions. The two liquid extracts were filtered and then pooled together for vacuum evaporation 25% (of the dry extract) of carrier was added, and the extract was evaporated to dryness. The obtained extract was then frozen at −18° C., and lyophilized, before being manually ground in a mortar, and subsequently conserved in a desiccator.

When tested using the general procedures described above the pea extracts had a slope of chelating activity above 100.

### Example 14

### Extraction of Spinach

The spinach raw material was received dry and crushed, and was used unaltered in the extraction.

The spinach raw material was extracted using water.

The raw material and solvent were placed in a jacketed reactor vessel, in a ratio of 15 mL of solvent for each gram of raw material and was mechanically shaken. The extract was then centrifuged, filtered and filtered again. The liquid extract was vacuum evaporated. 25% (of the dry extract) of maltodextrin was added, and the extract was evaporated to dryness. It was then frozen at −18° C., and lyophilized, before being manually crushed in a mortar. The extracts were subsequently conserved in a desiccator.

When tested using the general procedures described above the spinach extract has a slope of chelating activity above 25 and the scavenging activity of the spinach extract obtained by HPTLC-DPPH method was 39000 surface area of DPPH.

### Example 15

### Preparation of Mayonnaise Comprising Spinach and/or Peas

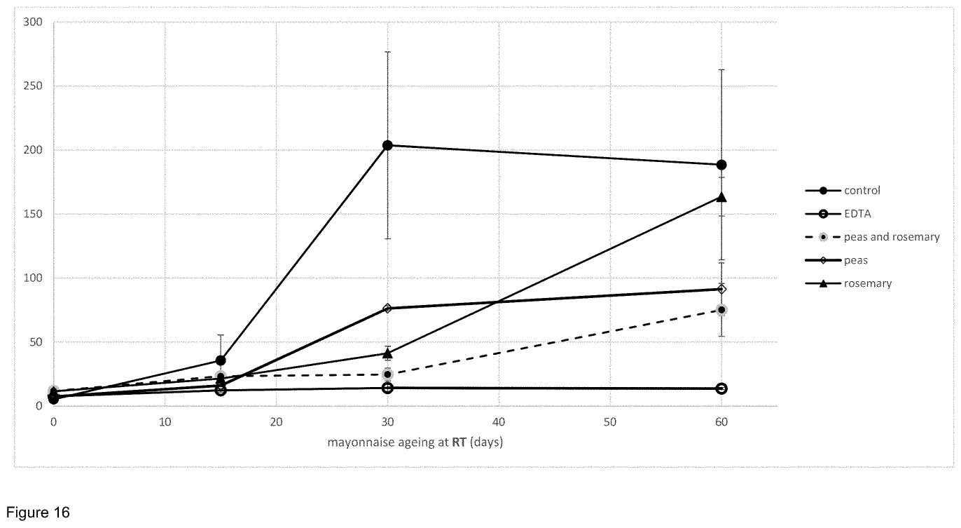

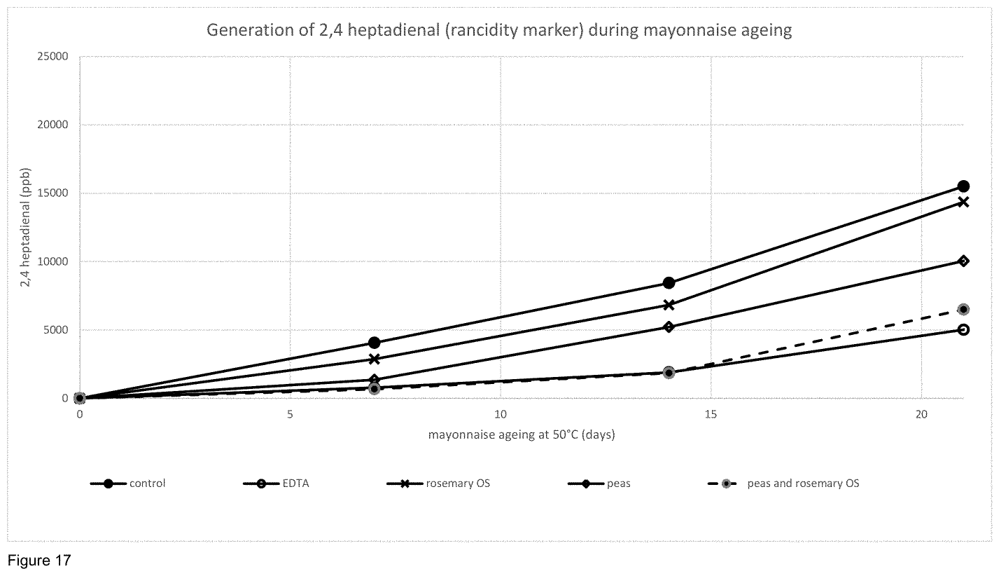

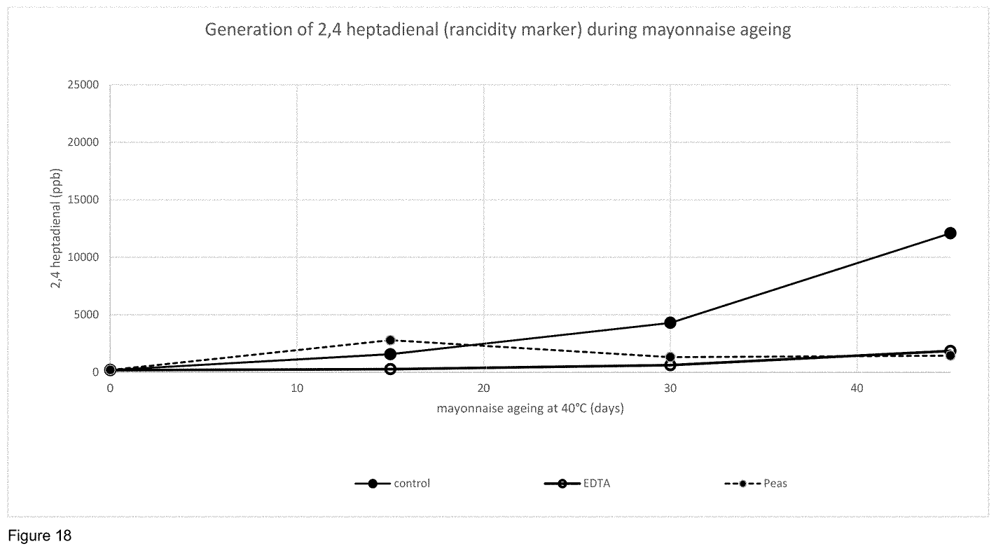

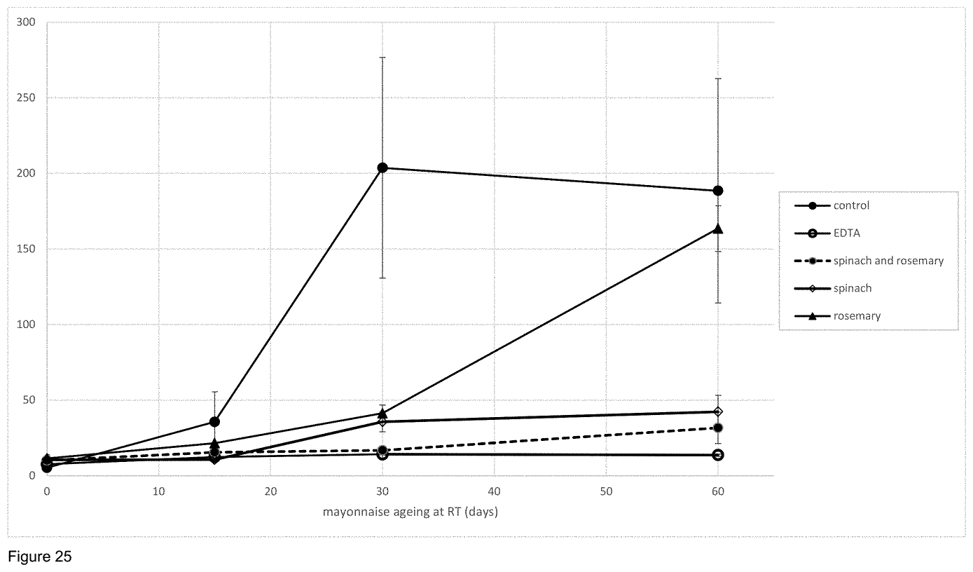

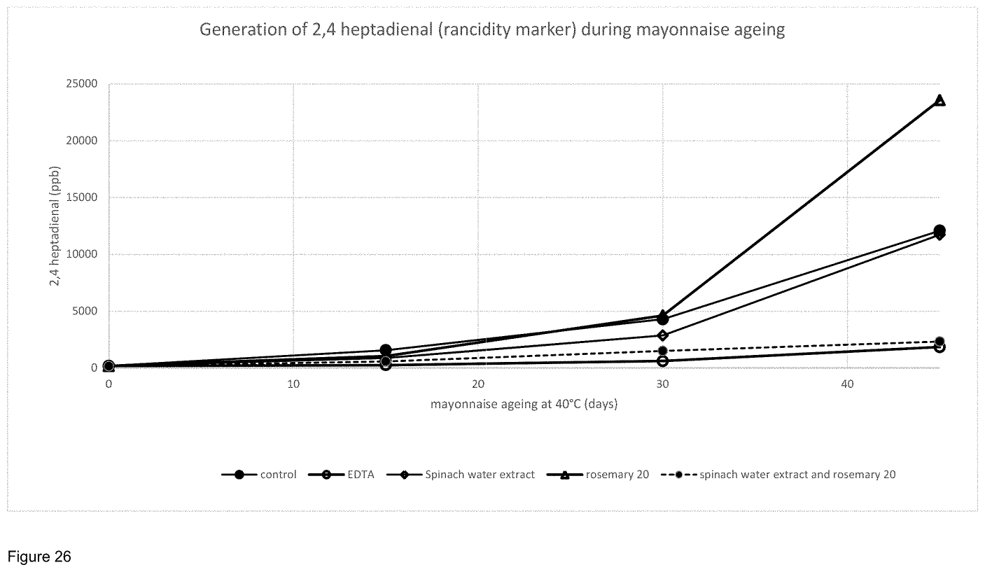

Spinach and/or peas extracts were added to the mayonnaise (prepared as in Examples 1 to 12) either alone or in combination with other extracts and aged at room temperature, 40° C. or at 50° C. for 2 or 1 months, respectively and prevented generation of 2,4 heptadienal in mayonnaises as shown in FIGS. 16, 17, 18, 25 and 26.

### Example 16

### Chelating Activities: Synergies

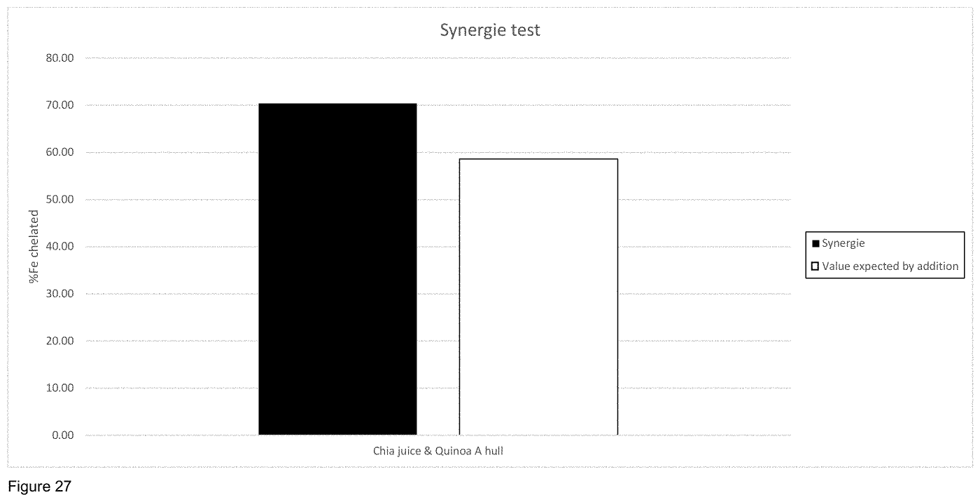

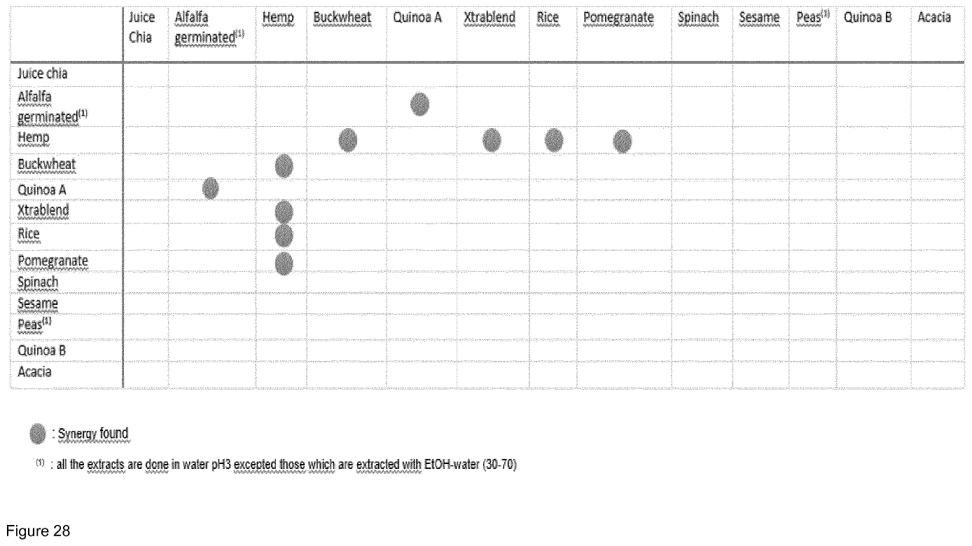

The different extracts were tested for their chelating activities by ferrozine test alone or in combination. Chelating activities of each extract were summed up and those sums were compared to the chelating activity of the corresponding extract combination. If the chelating activity of the extract combination was found to be higher than the sum of chelating activities of individual extracts, it was synergy. The results are shown in FIGS. 27 and 28.

1. A food stabilising composition comprising at least one plant derived inhibitor of fatty acid oxidation, wherein the at least one plant derived inhibitor comprises an extract or juice or product obtained from or obtainable from at least one plant selected from the group consisting of the Fabaceae family, the Lamiaceae family, the Amaranthaceae family and the Lythraceae family, and mixtures thereof, wherein when the at least one plant derived inhibitor comprises an extract or juice or product obtained or obtainable from the Lamiaceae family, the food stabilising composition must comprise an extract or juice or product obtained or obtainable from at least one plant selected from the group consisting of the Fabaceae family, the Amaranthaceae family and the Lythraceae family, and mixtures thereof.

2. The food stabilising composition according to claim 1, wherein the at least one plant derived inhibitor is extracted from the leaves and/or the fruit of the plant.

3. The food stabilising composition according to claim 1, wherein the at least one plant derived inhibitor comprises:
(a) an extract obtained from or obtainable from a plant of the Fabaceae family; and optionally
an extract obtained from or obtainable from a plant of the Lam iaceae family.

4. The food stabilising composition according to claim 1, wherein the at least one plant derived inhibitor comprises:
(a) an extract obtained from or obtainable from a plant of the Lam iaceae family; and
(b) (i) an extract obtained from or obtainable from a plant of the Fabaceae family; and/or
(ii) an extract obtained from or obtainable from a plant of the Amaranthaceae family.

5. The food stabilising composition according to claim 1, wherein the at least one plant derived inhibitor comprises an extract obtained from or obtainable from a plant of the Lythraceae family.

6. The food stabilising composition according to claim 1, wherein:
the at least one plant selected from the Fabaceae family is pea;
the at least one plant selected from the Lam iaceae family is rosemary;
the at least one plant selected from the Amaranthaceae family is spinach; and
the at least one plant selected from the Lythraceae family is pomegranate.

7. The food stabilising composition according to claim 1, wherein the at least one plant derived inhibitor is an extract obtained or obtainable from the group consisting of spinach, peas, pomegranate, rosemary and combinations thereof.

8. The food stabilising composition according to claim 1, wherein the at least one plant derived inhibitor comprises an extract or juice or product obtained or obtainable from: (i) rosemary and spinach; (ii) rosemary and pea; (iii) pea; or (iv) pomegranate.

9. The food stabilising composition according to claim 1, wherein the at least one plant derived inhibitor contains at least about 0.1% polyphenols by weight of the at least one plant derived inhibitor.

10. The food stabilising composition according to claim 1, wherein the at least one plant derived inhibitor contains less than about 5% citric acid by weight of the at least one plant derived inhibitor.

11. The food stabilising composition according to claim 1, wherein the at least one plant derived inhibitor is a combination of an extract, juice or product obtained or obtainable from two different plants selected from the group consisting of the Fabaceae family, the Lamiaceae family, the Amaranthaceae family and the Lythraceae family, wherein the weight ratio of each extract, juice or product is from about 1:99 to about 99:1.

12. A process for obtaining a food stabilising composition comprising the steps of:
(i) contacting at least one plant selected from the group consisting of the Fabaceae family, the Lamiaceae family, the Amaranthaceae family, the Lythraceae family and combinations thereof with a solvent; and
(ii) removing the solvent; or
a. crushing the at least one plant or fruit of the at least one plant selected from the group consisting of the Fabaceae family, the Lamiaceae family, the Amaranthaceae family, the Lythraceae family and combinations thereof to obtain juice from the at least one plant or the fruit of the at least one plant; and
b. evaporating the liquid from the juice or concentrating juice in presence of carbonates/and or hydroxyls and their corresponding salts.

13. The process according to claim 12, wherein the at least one plant selected from the group consisting of the Fabaceae family, the Lamiaceae family, the Amaranthaceae family, the Lythraceae family and combinations thereof is ground before contacting with saki solvent.

14. The food stabilising composition obtainable by the process according to claim 13.

15. A method for stabilising a foodstuff, nutrition and health matrix or cosmetics matrix comprising the step of contacting a foodstuff, nutrition and health matrix or cosmetics matrix with a stabilising composition according to claim 1.

16. The method according to claim 15, wherein the food stabilising composition inhibits or prevents oxidation of a foodstuff, nutrition and health matrix or cosmetics matrix by inhibiting or preventing the conversion of polyunsaturated fatty acid (PUFA) oils to 2,4-heptadienal and/or 2,4-decadienal in the foodstuff, nutrition and health matrix or cosmetics matrix.

17. The method according to claim 15, wherein the food stabilising composition is present in a foodstuff, nutrition and health matrix or cosmetics matrix in an amount from about 0.01% to about 5% by weight of the foodstuff, nutrition and health matrix or cosmetics matrix.

18. (canceled)

19. (canceled)

20. (canceled)

21. The method according to claim 15 wherein the foodstuff comprises an oil-in-water emulsion.

22. The method according to claim 21, wherein the oil-in-water emulsion is a mayonnaise.

23. The method according to claim 21, wherein the oil-in-water emulsion or mayonnaise is substantially free of EDTA.

24. A foodstuff comprising a food stabilising composition according to claim 1.

25. The foodstuff according to claim 24, wherein the foodstuff comprises an oil-in-water-emulsion.

26. The foodstuff according to claim 25, wherein the oil-in-water-emulsion is a mayonnaise.

27. The foodstuff according to claim 25, wherein the oil-in-water emulsion is substantially free of EDTA.

28. A method of preparing an oil-in-water emulsion according to claim 25 comprising the steps of:
(i) mixing a first aqueous phase, optionally with a stabilising composition according to claim 1;
(ii) adding oil to the product obtained in step (i), optionally with a stabilising composition according to claim 1; and
(iii) adding at least one further aqueous phase to the product obtained in step (ii).

29. The method according to claim 28, wherein the first aqueous phase comprises water and egg yolk.

30. The method according to claim 29, wherein the at least one further aqueous phase comprises vinegar.

31. The food stabilising composition according to claim 7, wherein the at least one plant derived inhibitor contains at least about 0.1% polyphenols by weight of the at least one plant derived inhibitor.

32. The food stabilising composition according to claim 7, wherein the at least one plant derived inhibitor comprises an extract or juice or product obtained or obtainable from: (i) rosemary and spinach; (ii) rosemary and pea; (iii) pea; or (iv) pomegranate.

33. A method for stabilising a foodstuff, nutrition and health matrix or cosmetics matrix comprising the step of contacting a foodstuff, nutrition and health matrix or cosmetics matrix with a stabilising composition according to claim 7.

34. A method for stabilising a foodstuff, nutrition and health matrix or cosmetics matrix comprising the step of contacting a foodstuff, nutrition and health matrix or cosmetics matrix with a stabilising composition according to claim 32.

35. The method according to claim 33, wherein the foodstuff comprises an oil-in-water emulsion.

36. The method or use according to claim 34 wherein the oil-in-water emulsion is substantially free of EDTA.

37. A foodstuff comprising a food stabilising composition according to claim 7.

38. A foodstuff comprising a food stabilising composition according to claim 32.

39. A method of preparing an oil-in-water emulsion according to claim 25 comprising the steps of:
(iv) mixing a first aqueous phase, optionally with a stabilising composition according to claim 7
(v) adding oil to the product obtained in step (i), optionally with a stabilising composition according to claim 7; and
(vi) adding at least one further aqueous phase to the product obtained in step (ii).

40. A method of preparing an oil-in-water emulsion according to claim 25 comprising the steps of:
(i) mixing a first aqueous phase, optionally with a stabilising composition according to claim 32
(ii) adding oil to the product obtained in step (i), optionally with a stabilising composition according to claim 32; and
(iii) adding at least one further aqueous phase to the product obtained in step (ii).
